(19) United States
(12) Patent Application Publication
(10) Pub. No.: US 2025/0184049 A1
(43) Pub. Date: Jun. 5, 2025

(54) CONFIGURING BASED ON NETWORK CODING

(71) Applicant: Lenovo (Singapore) Pte. Ltd., New Tech Park (SG)

(72) Inventors: Razvan-Andrei Stoica, Witten (DE); Hossein Bagheri, Dearborn Heights, MI (US); Vijay Nangia, Woodridge, IL (US)

(21) Appl. No.: 18/844,698

(22) PCT Filed: Mar. 7, 2023
(86) PCT No.: PCT/IB2023/052159

§ 371 Date: Sep. 6, 2024

Related U.S. Application Data
(60) Provisional application No. 63/317,214, filed on Mar. 7, 2022.

(51) Int. Cl. H04L 1/1867; H04L 27/26; H04W 72/232

(52) U.S. Cl. CPC H04L 1/1896; H04L 27/2607; H04W 72/232

(57) ABSTRACT

Apparatuses, methods, and systems are disclosed for configuring based on network coding (“NC”). One method includes determining, at a receiving device, a NC configuration for transmission of a scheduled network-coded application data unit (“ADU”). The method includes receiving the scheduled network-coded ADU in at least one transport block (“TB”). The method includes determining, for each TB of the at least one TB, a code block (“CB”) threshold based at least on the NC configuration. The method includes configuring, for each TB of the at least one TB, a NC-aware hybrid automatic repeat request (“HARQ”) process as a HARQ process with the CB threshold. The method includes using the CB threshold to determine a NC-aware HARQ feedback report. The method includes feeding back the NC-aware HARQ feedback report to a transmitting device.

### FIELD

The subject matter disclosed herein relates generally to wireless communications and more particularly relates to configuring based on network coding (“NC”).

### BACKGROUND

In certain wireless communications networks, extended reality (“XR”) may be used. In such networks, communications may not be efficient.

### BRIEF SUMMARY

Methods for configuring based on NC are disclosed. Apparatuses and systems also perform the functions of the methods. One embodiment of a method includes determining, at a receiving device, a NC configuration for transmission of a scheduled network-coded application data unit (“ADU”). In some embodiments, the method includes receiving the scheduled network-coded ADU in at least one transport block (“TB”). In certain embodiments, the method includes determining, for each TB of the at least one TB, a code block (“CB”) threshold based at least on the NC configuration. In various embodiments, the method includes configuring, for each TB of the at least one TB, a NC-aware hybrid automatic repeat request (“HARQ”) process as a HARQ process with the CB threshold. In some embodiments, the method includes using the CB threshold to determine a NC-aware HARQ feedback report. In certain embodiments, the method includes feeding back the NC-aware HARQ feedback report to a transmitting device.

One apparatus for configuring based on NC includes a receiving device. In some embodiments, the apparatus includes a processor that determines a NC configuration for transmission of a scheduled network-coded ADU. In various embodiments, the apparatus includes a receiver that receives the scheduled network-coded ADU in at least one TB, wherein the processor: determines, for each TB of the at least one TB, a CB threshold based at least on the NC configuration; configures, for each TB of the at least one TB, a NC-aware HARQ process as a HARQ process with the CB threshold; and uses the CB threshold to determine a NC-aware HARQ feedback report. In certain embodiments, the apparatus includes a transmitter that feeds back the NC-aware HARQ feedback report to a transmitting device.

Another embodiment of a method for configuring based on NC includes determining, at a network device, a NC configuration for encoding an ADU for transmission over a plurality of transport blocks (TBs). In some embodiments, the method includes determining a plurality of CB thresholds, wherein each CB threshold of the plurality of CB thresholds corresponds to each TB of the plurality of TBs to meet for successful NC decoding and recovery of the ADU. In certain embodiments, the method includes signaling the NC configuration, the plurality of CB thresholds, or a combination thereof to a receiver device for a NC-aware HARQ feedback of the plurality of TBs. In various embodiments, the method includes scheduling the ADU for transmission to a receiver device. In some embodiments, the method includes receiving an NC-aware HARQ feedback from the receiver device for each TB of the plurality of TBs. In certain embodiments, the method includes applying the NC-aware HARQ feedback to determine necessary TB retransmissions of the ADU.

Another apparatus for configuring based on NC includes a network device. In some embodiments, the apparatus includes a processor that: determines a NC configuration for encoding an ADU for transmission over a plurality of transport blocks (TBs); determines a plurality of CB thresholds, wherein each CB threshold of the plurality of CB thresholds corresponds to each TB of the plurality of TBs to meet for successful NC decoding and recovery of the ADU; signals the NC configuration, the plurality of CB thresholds, or a combination thereof to a receiver device for a NC-aware HARQ feedback of the plurality of TBs; and schedules the ADU for transmission to a receiver device. In various embodiments, the apparatus includes a receiver that receives an NC-aware HARQ feedback from the receiver device for each TB of the plurality of TBs, wherein the processor applies the NC-aware HARQ feedback to determine necessary TB retransmissions of the ADU.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring based on NC;

FIG. 2 is a schematic block diagram illustrating one embodiment of an apparatus that may be used for configuring based on NC;

FIG. 3 is a schematic block diagram illustrating one embodiment of an apparatus that may be used for configuring based on NC;

FIG. 4 is a schematic block diagram illustrating one embodiment of a split-rendering architecture system;

FIG. 5 is a schematic block diagram illustrating one embodiment of a communication system architecture;

FIG. 6 is a schematic block diagram illustrating one embodiment of integration of timing of NC at a radio link control (“RLC”) layer;

FIG. 7 is a schematic block diagram illustrating one embodiment of timing of a XR application downlink (“DL”)/uplink (“UL”) traffic model;

FIG. 8 is a schematic block diagram illustrating one embodiment of integration of timing of radio access network (“RAN”) and/or user equipment (“UE”) protocol stacks for an application serving DL traffic (e.g., XR and/or cloud gaming (“CGM”)) with NC sublayer enabled and HARQ feedback reports;

FIG. 9 is a schematic block diagram illustrating one embodiment of timing of network-coded transmissions with HARQ acknowledgement (“HARQ-ACK”) feedback upon receiving a TB with some erroneous CBs less than a determined threshold based on the NC redundancy level;

FIG. 10 is a schematic block diagram illustrating one embodiment of timing of network-coded transmissions with HARQ-NACK feedback upon receiving a TB with some erroneous CBs more than a determined threshold based on the NC redundancy level;

FIG. 11 is a schematic block diagram illustrating one embodiment of timing of code block group (“CBG”)-based retransmission with proposed NC-aware HARQ process monitoring procedure (e.g., initial transmission);

FIG. 12 is a schematic block diagram illustrating one embodiment of timing of CBG-based retransmission with proposed NC-aware HARQ process monitoring procedure (e.g., CBG #1 retransmission);

FIG. 13 is a schematic block diagram illustrating one embodiment of timing of consecutive and non-consecutive CB errors and a mapping to network-coded packets;

FIG. 14 is a flow chart diagram illustrating one embodiment of a method for configuring based on NC; and

FIG. 15 is a flow chart diagram illustrating another embodiment of a method for configuring based on NC.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

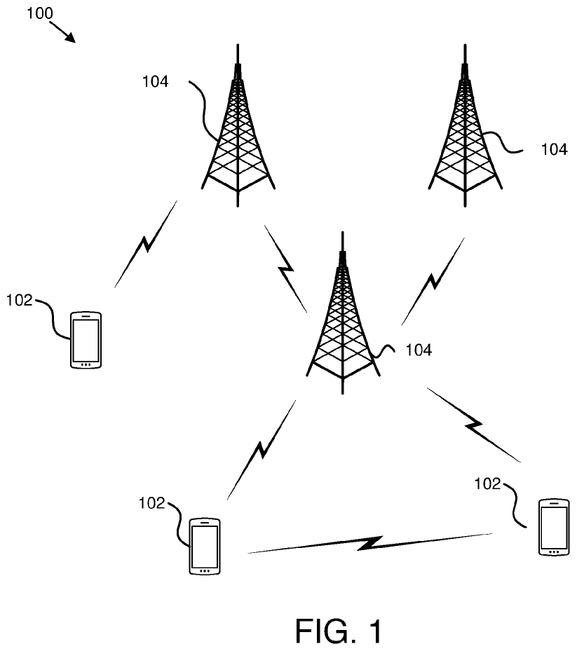

FIG. 1 depicts an embodiment of a wireless communication system 100 for configuring based on NC. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a RAN, a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-third generation partnership project (“3GPP”) gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an orthogonal frequency division multiplexing (“OFDM”) modulation scheme on the DL and the remote units 102 transmit on the UL using a single-carrier frequency division multiple access (“SC-FDMA”) scheme or an OFDM scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may determine, at a receiving device, a NC configuration for transmission of a scheduled network-coded ADU. In some embodiments, the remote unit 102 may receive the scheduled network-coded ADU in at least one TB. In certain embodiments, the remote unit 102 may determine, for each TB of the at least one TB, a CB threshold based at least on the NC configuration. In various embodiments, the remote unit 102 may configure, for each TB of the at least one TB, a NC-aware HARQ process as a HARQ process with the CB threshold. In some embodiments, the remote unit 102 may use the CB threshold to determine a NC-aware HARQ feedback report. In certain embodiments, the remote unit 102 may feed back the NC-aware HARQ feedback report to a transmitting device. Accordingly, the remote unit 102 may be used for configuring based on NC.

In certain embodiments, a network unit 104 may determine, at a network device, a NC configuration for encoding an ADU for transmission over a plurality of transport blocks (TBs). In some embodiments, the network unit 104 may determine a plurality of CB thresholds, wherein each CB threshold of the plurality of CB thresholds corresponds to each TB of the plurality of TBs to meet for successful NC decoding and recovery of the ADU. In certain embodiments, the network unit 104 may signal the NC configuration, the plurality of CB thresholds, or a combination thereof to a receiver device for a NC-aware HARQ feedback of the plurality of TBs. In various embodiments, the network unit 104 may schedule the ADU for transmission to a receiver device. In some embodiments, the network unit 104 may receive an NC-aware HARQ feedback from the receiver device for each TB of the plurality of TBs. In certain embodiments, the network unit 104 may apply the NC-aware HARQ feedback to determine necessary TB retransmissions of the ADU. Accordingly, the network unit 104 may be used for configuring based on NC.

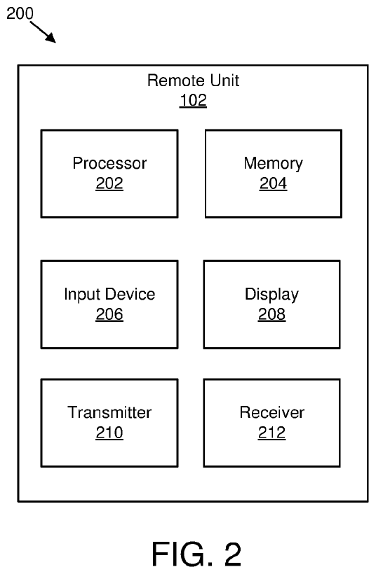

FIG. 2 depicts one embodiment of an apparatus 200 that may be used for configuring based on NC. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 determines a NC configuration for transmission of a scheduled network-coded ADU. In various embodiments, the receiver 212 receives the scheduled network-coded ADU in at least one TB. The processor 202: determines, for each TB of the at least one TB, a CB threshold based at least on the NC configuration; configures, for each TB of the at least one TB, a NC-aware HARQ process as a HARQ process with the CB threshold; and uses the CB threshold to determine a NC-aware HARQ feedback report. In certain embodiments, the transmitter 210 feeds back the NC-aware HARQ feedback report to a transmitting device.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

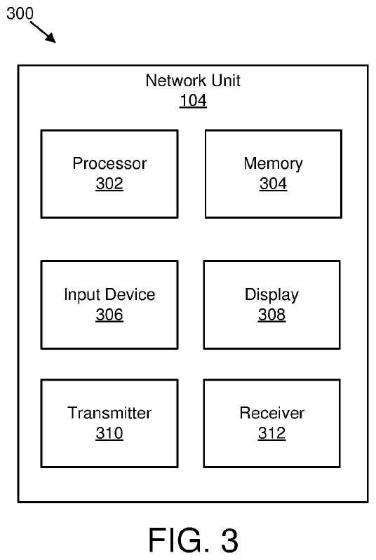

FIG. 3 depicts one embodiment of an apparatus 300 that may be used for configuring based on NC. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302: determines a NC configuration for encoding an ADU for transmission over a plurality of transport blocks (TBs); determines a plurality of CB thresholds, wherein each CB threshold of the plurality of CB thresholds corresponds to each TB of the plurality of TBs to meet for successful NC decoding and recovery of the ADU; signals the NC configuration, the plurality of CB thresholds, or a combination thereof to a receiver device for a NC-aware HARQ feedback of the plurality of TBs; and schedules the ADU for transmission to a receiver device. In various embodiments, the receiver 312 receives an NC-aware HARQ feedback from the receiver device for each TB of the plurality of TBs. The processor 202 applies the NC-aware HARQ feedback to determine necessary TB retransmissions of the ADU.

It should be noted that one or more embodiments found herein may be combined together. In certain embodiments, there may be a service-oriented design considering XR traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink, (e) various degrees of importance between I/P/B-frames in contributing to the end-to-end quality of user experience) to enable more efficient (e.g., in terms of satisfying XR service requirements for a greater number of UEs, in terms of UE power saving, or in terms of XR traffic reliability and rendering robustness against wireless networks transmissions effects) XR service delivery.

In some embodiments, there may be NC, or fountain codes (e.g., whereby a code can generate an unbounded number of repair symbols as redundancies to counteract potential erasures due to transmission channel losses) at a packet level considered within radio access networks for reducing a latency of XR traffic by means of reduced or eliminated retransmissions feedback (e.g., hybrid automatic repeat request (“HARQ”), automatic repeat request (“ARQ”)), while also increasing the reliability of the XR associated traffic.

In various embodiments, for XR traffic combining low-latency, quasi-periodic, high-throughput data bursts, NC procedures may be used to maintain simultaneously a high spectral efficiency and low latency, by optimizing a required level of redundancy needed to avoid an unnecessary high quota of repair packets or retransmissions. To this extent, efficient feedback reporting of the NC-aware acknowledgement state for the received information is essential to provide to a transmitter the necessary statistics related to the channel conditions for adaptation of the NC, channel coding, and modulation configurations of subsequent transmissions.

In certain embodiments, there may be mechanisms for NC-aware acknowledgement feedback of network coded radio access network transmissions as enhanced HARQ feedback meant to provide necessary link information to the network to effectively adapt its coding and transmission characteristics. Concretely, a NC-aware HARQ feedback procedure and associated signaling mechanisms are used.

In some embodiments, XR is an umbrella term for different types of realities including: 1) virtual reality (“VR”) which is a rendered version of a delivered visual and audio scene—the rendering is designed to mimic the visual and audio sensory stimuli of the real world as naturally as possible to an observer or user as they move within the limits defined by the application-virtual reality usually, but not necessarily, requires a user to wear a head mounted display (“HMD”) to completely replace the user's field of view with a simulated visual component, and to wear headphones, to provide the user with the accompanying audio-some form of head and motion tracking of the user in VR is usually also necessary to allow the simulated visual and audio components to be updated to ensure that, from the user's perspective, items and sound sources remain consistent with the user's movements-additional means to interact with the virtual reality simulation may be provided but are not strictly necessary; 2) augmented reality (“AR”) which is when a user is provided with additional information or artificially generated items, or content overlaid upon their current environment-such additional information or content will usually be visual and/or audible and their observation of their current environment may be direct, with no intermediate sensing, processing, and rendering, or indirect, where their perception of their environment is relayed via sensors and may be enhanced or processed; and/or 3) mixed reality (“MR”) which is an advanced form of ΔR where some virtual elements are inserted into the physical scene with the intent to provide the illusion that these elements are part of the real scene.

In various embodiments, XR refers to all real-and-virtual combined environments and human-machine interactions generated by computer technology and wearables. It includes representative forms such as AR, MR, and VR and the areas interpolated among them. The levels of virtuality range from partially sensory inputs to fully immersive VR. A key aspect of XR is the extension of human experiences especially relating to the senses of existence (e.g., represented by VR) and the acquisition of cognition (e.g., represented by AR).

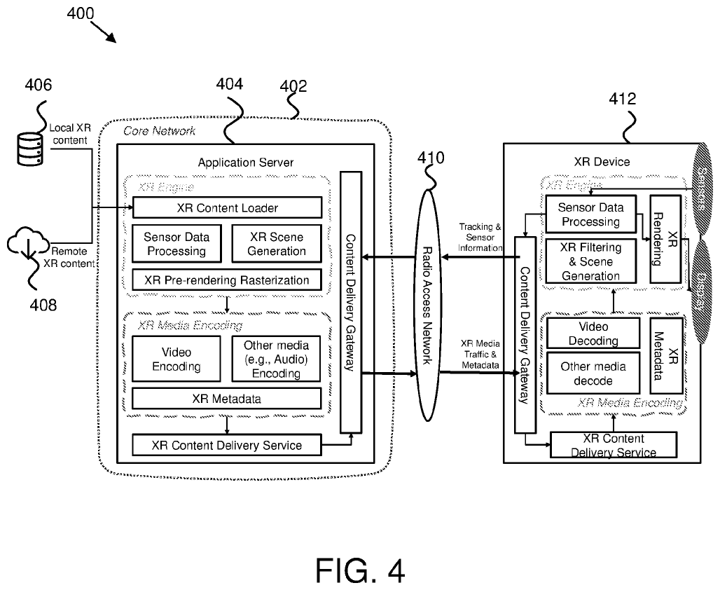

In certain embodiments, a common setup adopted at a 3GPP level for immersive XR and high-performance video content transmissions relies on a concept of split rendering. This uses an application server located at an edge and connected to a core network (“CN”) which is used to encode the application video content and transfer it to a RAN for mobile communications. In exchange, the RAN communicates with a connected UE which may use additional hardware and/or software processing to render the video content to match a user's pose, inputs, and/or control state. This architectural approach is displayed for reference in FIG. 4.

FIG. 4 is a schematic block diagram illustrating one embodiment of a split-rendering architecture system 400. The system 400 includes a CN 402 that includes an application server 404 that communicates local XR content 406 and remote XR content 408. The CN 402 communicates with a RAN 410. Further, the system 400 includes an XR device 412 (e.g., UE device) that communicates with the RAN 410. The split-rendering architecture for mobile networks is based on an edge and/or cloud video application server (e.g., application server 404) and the XR device 412. The application server 404 may deliver XR media based on local XR processed content or on remote XR processed content. The processing may account for and/or further process tracking and sensing information as uplinked by the XR device 412. The application server 404 streams the XR multimedia content via a content delivery gateway to which the XR device 412 is connected via any real-time transport protocol. The XR device 412, after decoding the XR content received from the application server 404, may use its XR engine and additional local hardware and/or software capabilities and/or XR pre-rendered content, and XR associated XR metadata to locally render the XR content on a display.

The video application server 404 is used therefore to process, encode, and/or transcode and serve local or remote video content pertaining to an XR and/or CGM application session to the XR device 412. The video application server 404 may as a result encode and/or transcode and control the video viewport content and transmit it in downlink to the RAN based on UE specific parameters, configurations and sensing inputs that may affect the rendering perspective, rate, quality, panning, and so forth. This architecture may be expected to leverage the advantages of various compute and network domains (e.g., cloud, edge, smart handsets and/or headsets) to enable scalable XR and/or CGM applications and use cases with low-latency, high rate, and efficient energy usage. The architecture may be universally applicable both to split rendering with asynchronous time warping devices (e.g., where the video application server 404 encodes a rasterized pre-processed viewport representation to aid the UE), or to split rendering with viewport rendering at the device side (e.g., where the video viewport may be completely or partially rendered at the device side given the media encoded video content and its corresponding metadata available).

In certain embodiments, XR traffic in DL is generically characterized by a quasi-periodic, jitter-affected packet arrival rate determined by the XR application frame generation rate periodicity (e.g., 30, 60, 90, and/or 120 fps). As such, the average packet arrival periodicity is obtained as the reciprocal of the application frame rate (e.g., 16.67 ms= 1/60 fps). Thus, the periodic arrival time without jitter at gNB of XR packets indexed by k=1,2,3, . . . is shown in Equation 1, where F denotes the XR application video frame generation rate (e.g., per second).

$${τ}_{k} = \frac{k}{F} \cdot 1000 [ ms ] , \qquad Equation 1$$

This periodic packet arrival model of Equation 1 implicitly assumes fixed a delay contributed from a network side including fixed video encoding time, fixed network transfer delay, and so forth.

However, in some embodiments in a real system, a varying frame encoding delay and network transfer time introduces stochastic jitter in packet arrival time at gNB. Generically, the jitter is modelled as a truncated Gaussian random process resulting into a random variable added on top of periodic arrivals. The jitter contribution to the packet arrival time thus generates an additive truncated Gaussian distribution to the inherent ideal periodicity of the XR DL traffic with statistical parameters as in Table 1.

TABLE 1
Statistical parameters for jitter of downlink XR traffic

| | | | Optional model |
|---|---|---|---|
| | Unit of | Baseline model value | value for |
| Parameter | measure | for evaluation | evaluation |
| Mean | ms | 0 | |
| Standard deviation | ms | 2 | |
| Truncation range | ms | [−4, 4] | [−5, 5] |

In various embodiments, given the jitter model of Table 1 considered in 3GPP for fifth generation (“5G”) and beyond AN, even for high frame generation rates (e.g., 120 fps), the combined realistic XR DL traffic model ensures in-order packet arrivals (e.g., arrival time of a next packet is always larger than that of the previous packet). Concretely, the XR DL traffic model of periodic arrival with jitter for an arrival time of a video frame packet with index k=1,2,3, . . . is summarized by Equation 2, where F is the given frame generation rates (per second) and/is the jitter specific random variable following the model of Table 2, and respectively, the offset represents an arbitrary UE specific shift in packet arrival timing.

$${τ}_{k} = offset + \frac{k}{F} \cdot 1000 + J [ ms ] , \qquad Equation 2$$

In certain embodiments, in the UL direction, the XR and/or CGM traffic is similarly generically characterized by user inputs, control metadata, pose updates, panning information, and the like, and the latter is modelled by an UL pose and/or control stream traffic model where packets arrive at the UE periodically with parameters tabulated as in Table 2.

TABLE 2
Statistical parameters for the UL XR,
CGM pose, and/or control traffic model

| | | Baseline values for |
|---|---|---|
| Parameters | unit | evaluation |
| Periodicity | ms | 4 |
| Jitter | ms | No jitter |
| Packet size | byte | 100 |
| PDB | ms | 10 |

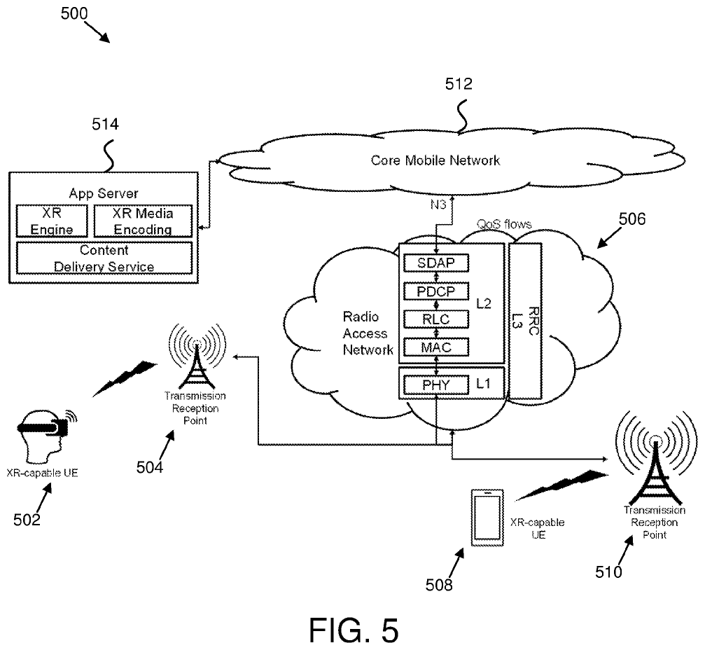

FIG. 5 is a schematic block diagram illustrating one embodiment of a communication system 500 architecture. The communication system 500 includes a first XR-capable UE 502, a first transmission reception point (“TRP”) 504, a RAN 506, a second XR-capable UE 508, a second TRP 510, a core mobile network 512, and an application (“app”) server 514. FIG. 5 includes the source application server 514 connected (e.g., possibly at the edge) to the core mobile network 512 which is connected to the RAN 506 serving subscribed and connected user equipment. As illustrated in FIG. 5 Error! Reference source not found., the protocol data units (“PDUs”) associated with an XR application session of an application server connected to a core network (“CN”) is transferred via the CN user plane function (“UPF”) over the internet protocol (“IP”) to the mobile RAN. The multimedia traffic may be further supported by a real-time multimedia transport protocol such as a real-time transport protocol (“RTP”) or alike to handle jitter, packet loss, and out-of-order deliveries that may occur within a typical IP network setup.

The quality of service (“QoS”) associated with IP packets of the XR traffic is handled by the CN via QoS flows generated at the UPF within the established PDU session. This procedure is opaque to the RAN 506 which only manages the mapping of QoS flows associated with the received IP packets to their corresponding DRBs given the QoS profile associated with the indicators of each QoS flow. In a 5G system (“5GS”), for instance, the QoS flows will be characterized by the 5G QOS identifier (“5QI”). This latter mapping of QoS flows to data radio bearers (“DRBs”) is performed within the RAN by the service data adaptation protocol (“SDAP”) layer. The SDAP PDU is then processed by the packet data convergence protocol where among others header compression and ciphering are performed and the outputs further processed by the RLC. The RLC may perform segmentation of the packet data convergence protocol (“PDCP”) PDUs and implements the automatic request response (“ARQ”) repetition retransmissions. The RLC PDUs are then processed over the logical channels interfaces by the medium access control (“MAC”) layer which handles the logical channels multiplexing, hybrid automatic repeat request (“HARQ”), scheduling, and scheduling retransmission functions. Lastly, the MAC PDUs are combined over the transport channel into transport blocks (“TBs”) at the level of physical (“PHY”) layer. The PHY handles the coding and/or decoding, rate matching, modulation and/or demodulation, radio resource mapping, multiantenna mapping, and other typical radio low-level functions.

The PHY TBs, which are appended with their own cyclic redundancy check (“CRC”) of 16 or 24 bits blocks for detection of errors, are further partitioned into same-sized CBs. The CBs are appended as well by 24 bits CRC for error detection and following this operation they are forward error correction (“FEC”) encoded by the PHY. The HARQ procedure within 5G NR ensures incremental redundancy retransmissions of an entire TB if any of the CBs or TB CRC checks fails thus effectively ensuring reliability over the wireless link. In addition, given the increasing size of TBs, 5G NR also introduced a CBG construct to group one or more CBs into CBGs. The CBGs, if configured appropriately via radio resource control (“RRC”), support independent HARQ via downlink control information (“DCI”) signaling primarily via CBG transmit indicator (“CBGTI”) and CBG flush indicator (“CBGFI”) within the same HARQ process as the enclosing TB. As such, some mechanisms for versatile retransmissions are present in fifth generation (“5G”) new radio (“NR”) to reduce retransmissions delays and resource utilization, applicable also to high-rate low-latency traffic such as immersive XR and/or CGM media applications. Yet these procedures are purely based on traditional FEC mechanisms, applied at a bit-level unaware of XR application data units (“ADUs”) (e.g., the smallest unit of data that can be processed independently by an application, e.g., a video frame, a slice of a video frame, and so forth) and XR traffic characteristics.

In certain embodiment, NC is a general procedure to provide packet-based redundancy for increasing the reliability of communications systems over packet-switched networks. NC provides by means of linear combinations over (e.g., finite) Galois fields, or alternatively, by random XORing operations repair packets (e.g., or symbols) which act as redundancy packets meant to provide to a receiver the redundant information to potentially recover originally transmitted data.

In some embodiments, concretely, given a set of K information packets (e.g., or symbols) {S₁, S₂, . . . , S_{K}} of the same size, a linear network-coded packet is obtained by the combination Rⱼ=Σᵢ₌₁^{K} gᵢⱼ·Sᵢ, whereby the encoding coefficients vector gⱼ=[g₁ⱼ, g₂ⱼ, . . . , g_{Kj}]^{T} is formed by values from a Galois field F, e.g., F₂, F₈, F₂₅₆, and so forth. By optimization and selection of a proper distribution of the vectors g∈F^{K}, an infinite number of redundant network coded packets may be thus coded. Considering a fix number N of packets to be generated by a generator coefficient matrix G=[g₁, g₂, . . . , g_{N}]∈F^{K×N}, selected such that any K columns of G are linearly independent, whereby the latter condition is exactly fulfilled if G is the generator matrix of a maximum distance separable (“MDS”) code, e.g., Reed-Solomon code, or is asymptotically fulfilled if G is randomly generated over a sufficiently large field size. Probabilistic constructions of the latter randomization strategy for determining G may minimize the field size and increase encoding efficiency of asymptotic and numeric constructions by means of optimization of the degree distribution of each encoded repair packet (or symbol), e.g., as for Luby transform (“LT”) and derivatives Raptor, and RaptorQ codes thereof.

In various embodiments, given an ideal linear network code, whereby any K columns of G are linearly independent such any K×K reduced matrix G′ is full rank, the original K packets (or symbols) can be recovered by Gaussian elimination or inverse encoding operation (or XORing) with G′⁻¹. As a consequence, the original K packets (or symbols) can be recovered from any K′≥K received packets (or symbols), whether they are systematic information packets (or symbols) or repair packets (or symbols), respectively.

In certain embodiments, network codes make them applicable as error correction mechanisms against packet (or symbols) erasures, benefitting with transmit and path diversity. To this end, they have been successfully used at the network level as error correction mechanism aiding the transmission control protocol (“TCP”) congestion control mechanism for reducing retransmissions needs, inherent latency, and alleviating congestion effects of reliable transmission protocols over the IP based systems.

In some embodiments, NC may be used for multicast broadcast transmissions as an application level FEC for file delivery over unidirectional transport (e.g., in downlink for content download), and for multi-hop communications at the 5G RAN level in the context of integrated access and backhaul (“IAB”) deployments. Furthermore, NC may be used as an enabler to outer coding immersive and/or interactive XR and/or CGM applications with high-rate and low-latency requirements given the increased packet-wise reliability and potential latency reduction (e.g., by avoiding higher layer retransmissions).

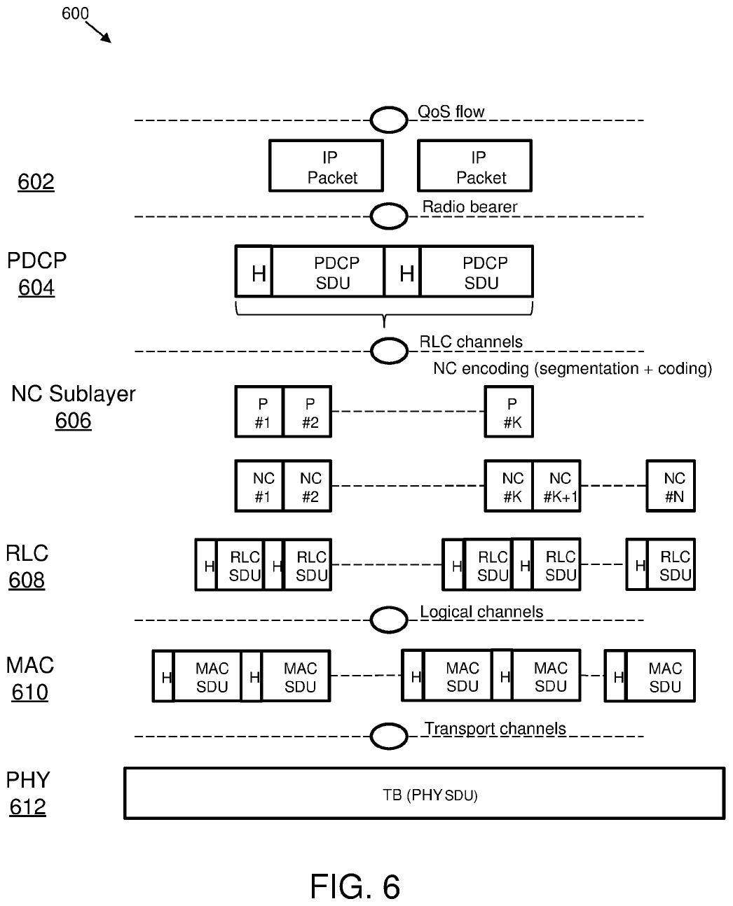

In various embodiments, NC may be used as outer coding for the XR DL unicast transmission link between the next generation node B (“gNB”) and a UE, whereby the network code applied at the RLC layer (e.g., on the PDCP PDU) spanning over an ADU, as shown in FIG. 6.

FIG. 6 is a schematic block diagram illustrating one embodiment of timing 600 of integration of NC at an RLC layer. The timing 600 shows SDAP 602, PDCP 604, NC sublayer 606, RLC 608, MAC 610, and PHY 612. Application of random linear NC at the level of the long term evolution (“LTE”) and 5G RAN stacks respectively and studied various architectural possibilities, with similar proposals either at the RLC layer or at the PDCP layer. It should be noted that none of the previous works performed an explicit analysis of HARQ and/or ARQ required modifications for NC PDU sessions over the RAN utilizing prior art HARQ and/or ARQ retransmissions mechanisms, either as in no feedback mode or in full feedback mode as detailed next.

In certain embodiments, retransmissions are inherently embedded into a protocol stack of LTE and/or 5G RAN for reliability purposes over wireless channels. Three levels of protection may be available across the stack at different layers with varying characteristics of reliability, latency, and overall role, as follows at: 1) PDCP layer: a) PDCP retransmissions are used for acknowledged mode (“AM”) configurations in case of handovers or whenever necessary to ensure in-order delivery of PDUs based on configured PDCP status reports, b) PDCP duplication is the main redundancy mechanism at this layer relying on simple repetition coding, c) PDCP retransmissions delays may vary between 50-150 ms depending on the data radio bearer air interface configuration, including subcarrier spacing (“SCS”) and modulation and coding scheme (“MCS”); 2) RLC layer: a) RLC retransmissions are used only for AM configurations to ensure reliable delivery of RLC PDUs, b) RLC relies on automatic repeat request (“ARQ”) (e.g., simple repetition-based retransmissions) as redundancy mechanism upon receival of status reports from the peer receiving protocol, c) RLC retransmission delays may vary between 10-50 ms based on the infrequent status reports feedback and air interface configuration, including SCS and MCS; and 3) PHY layers: a) PHY retransmissions rely on hybrid ARQ (e.g., HARQ) mechanism with soft combining embedding FEC channel coding with ARQ retransmissions for a highly robust and adaptive retransmission scheme ensuring high reliability, b) PHY retransmissions are controlled by individual HARQ processes within a HARQ entity as part of the MAC and are scheduled accordingly by the latter given the HARQ feedback of a receiver indication non-acknowledgement (e.g., NACK) (or equivalently HARQ-NACK), c) PHY retransmission delays may vary between 2-10 ms based on the scheduling, SCS and MCS configurations.

In some embodiments, placing network and/or outer coding sub-layer between PDCP and RLC layers allows one to: 1) take advantage of segmentation function of the RLC layer; 2) adapt network and/or outer coding parameters, such as the redundancy level, based on channel conditions; and/or 3) apply network/outer coding on specific radio bearers.

In various embodiments, at a network and/or outer coding sub-layer, k sub-packets are encoded into n=k*(1+y %) for y % of redundancy. These coded packets are subsequently processed by RLC, MAC, and PHY layers. XR traffic characteristics include relatively high data rate, stringent latency bound, and reliability requirements. Given these requirements, the addition of NC as outer coding (“OC”) in the RAN protocol stack together with exploiting link diversity provide performance benefits over other existing NR schemes, such as baseline HARQ and PDCP duplication. Redundancy added upfront for NC could help XR traffic to fulfil latency and reliability requirements without having to resort to HARQ and/or RLC retransmissions that would increase the delay of packet reception, especially in cases of blocking. Compared to the PDCP duplication, NC can offer adaptive redundancy, which allows for more efficient operation by adapting to the current traffic load and reliability and/or latency requirements. Constant redundancy of PDCP duplication may result in excessive system load, stalling the traffic and reducing capacity. FIG. 6 illustrates this architecture of the NC sublayer 606.

In certain embodiments: 1) for XR and cloud gaming traffic, the network and/or outer coding with HARQ disabled can result in both latency and power benefits compared to the HARQ enabled case with no added redundancy; 2) for XR and cloud gaming traffic in frequency range 2 (“FR2”) without carrier aggregation, the network and/or outer coding with HARQ disabled can result in both latency and power benefits compared to the HARQ enabled case with no added redundancy in certain cases; and/or 3) for XR and cloud gaming traffic in FR2 with carrier aggregation, the NC with HARQ disabled can result in both latency and power benefits compared to the HARQ enabled case with no added redundancy in all cases.

In some embodiments, a behavior of NC without HARQ feedback versus baseline 5G HARQ non-NC transmissions could be implemented under fixed MCS assumptions, and different NC redundancy levels. As such, no dynamic outer loop control for the joint NC redundancy level and MCS configuration can be considered or explicitly described, which will negatively impact the potential of higher spectral efficiency for NC-based transmissions. In fact, NC has greater potential of spectral efficiency by means of adaptive redundancy configuration and MCS selection which considers both the link signal-to-interference-noise ratio (“SINR”) as well as the link-diversity (e.g., spatial layers, time resources, propagation paths (e.g., dual connectivity, multi-hop relaying, carrier aggregation, etc.)). Since this dynamic adaptation is not possible without explicit feedback, HARQ disablement may require additional signaling to acquire necessary channel quality indicator (“CQI”), channel state information (“CSI”), or similar information to aid for adaptation of NC redundancy and MCS to link SINR conditions.

In various embodiments, there may be HARQ feedback and retransmissions configuration, and procedures associated with NC in support of adaptation of redundancy levels and MCS.

In certain embodiments, low-latency HARQ based mechanisms for increasing reliability, spectral efficiency of high-rate, low-latency, and quasi-periodic data traffic specific for instance to immersive media applications such as XR and CGM may be provided. To this end, NC outer coding redundancy, HARQ procedures, and various optimization thereof may be used for eliminating and/or reducing latency of necessary retransmissions and feedback reporting.

In some embodiments, given the XR and/or CGM DL and UL traffic periodicity, embodiments and examples in the sequel assume a basic scenario where XR video coded frames and associated codec metadata are mainly transported over the air interface over the physical downlink shared channel (“PDSCH”) in DL at a periodicity of

$$\frac{1}{fps}$$

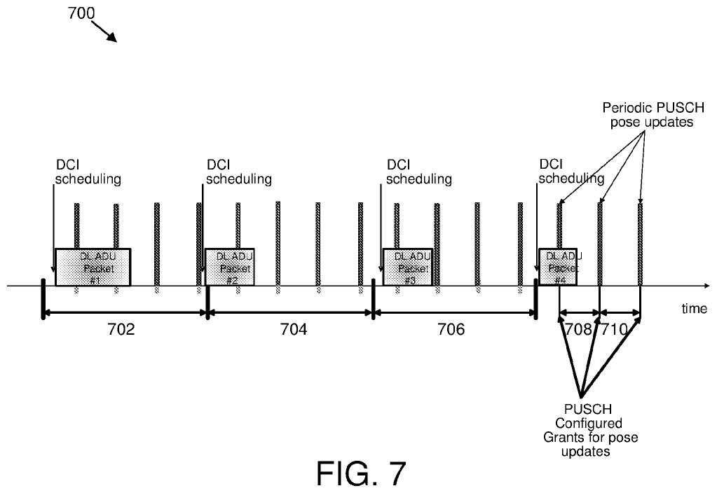

with the stochastic jitter model previously described, whereas in UL the user pose, inputs and associated application metadata are transported over the physical uplink shared channel (“PUSCH”). As an example, consider video codec frame rate at 60 fps (e.g., corresponding to PDSCH periodicity of 16.67 ms), whereas the UL pose update is considered at 4 ms as outlined in FIG. 7.

FIG. 7 is a schematic block diagram illustrating one embodiment of timing 700 of a XR application DL/UL traffic model. The timing 700 illustrates a periodicity

$$\frac{1}{fps}$$

702, 704, and 706 (e.g., 16.67 ms). Further, the timing 700 includes a periodicity 708 and 710 between periodic PUSCH pose updates (e.g., 4 ms). In various embodiments, the NC architecture outlined in FIG. 6 is enabled for DL and applied at a ADU level (e.g., for each ADU burst of PDCP PDUs), whereas the prior art baselines may consist of: 1) complete HARQ disablement for network-coded transmissions; and/or 2) 5G NR RAN HARQ.

In some embodiments, there may be: 1) a HARQ disablement which: a) does not provide low-latency mechanisms to adapt the redundancy levels of the NC and of the MCS and relies on delay-intensive higher level status reports (e.g., RLC status reports, NC sub-layer reports, PDCP status reports) or explicit CSI determination and/or reports by explicit sounding and/or reports procedures providing such information (e.g., CSI, CQI, link quality indicator (“LQI”), etc.), b) in case of low SINR relative to the protection redundancy level selected by a higher layer configuration it leads to delay bursts as the NC decoding fails only post RLC layer, incurring thus at least a 10 ms delay and exceeding the packet delay budget (“PDB”) of the XR ADUs, and c) excludes the possibility of the multiplexing other radio bearers containing non-network-coded RLC PDUs within the same TB as the network-coded content, or alternatively, of control elements from lower layers, such as MAC control elements (“MAC-CEs”); and/or 2) a 1-bit HARQ ACK and/or NACK reporting per unit of transport (e.g., CBG and/or TB) which: a) may not apply to network-coded TBs, as part of the TBs that are received wrongly can be recovered by the added higher layer redundancy, and despite being able to correctly decode the information at higher layers, the PHY layer errors would report NACK which in terms would require unnecessary retransmissions at the HARQ layer, and b) may not be a sufficient report for the gNB to determine the dynamic adaptation of the NC redundancy level and/or of the MCS selection, especially given the inaccuracy of the latter mechanism as explained above.

While certain embodiments are described in the context of XR traffic, the embodiments are generally applicable to any kind of traffic bursts modelled similarly in DL by fixed periodicity with stochastic jitter with high-rate and low-latency requirements, and respectively, in UL potential periodic traffic bursts.

In various embodiments, instead of recurring to prior art HARQ procedures (e.g., either full disablement or enablement without NC awareness), it is beneficial to provide a NC-aware HARQ procedure and associated feedback report to avoid certain disadvantages while providing the following gains: 1) low-latency HARQ-based feedback including NC awareness (e.g., coding procedure, coding redundancy level, etc.); 2) aggregation of HARQ feedback reports per one or more XR ADUs undergoing network-coded transmissions; 3) extended feedback report (e.g., more than ACK and/or NACK 1 bit width feedback determining the successive syntactically correct receival of the data transmissions) including indications of how well the data was decoded post FEC decoding for accommodating low-latency dynamic adaptation mechanisms and outer loop control at gNB for NC redundancy level and MCS determination; and/or 4) prioritized NACK feedback and early indication of ADU transmission failure for the gNB to determine with low-latency actions to undertake for error correction (e.g., retransmission, ADU dropping, etc.).

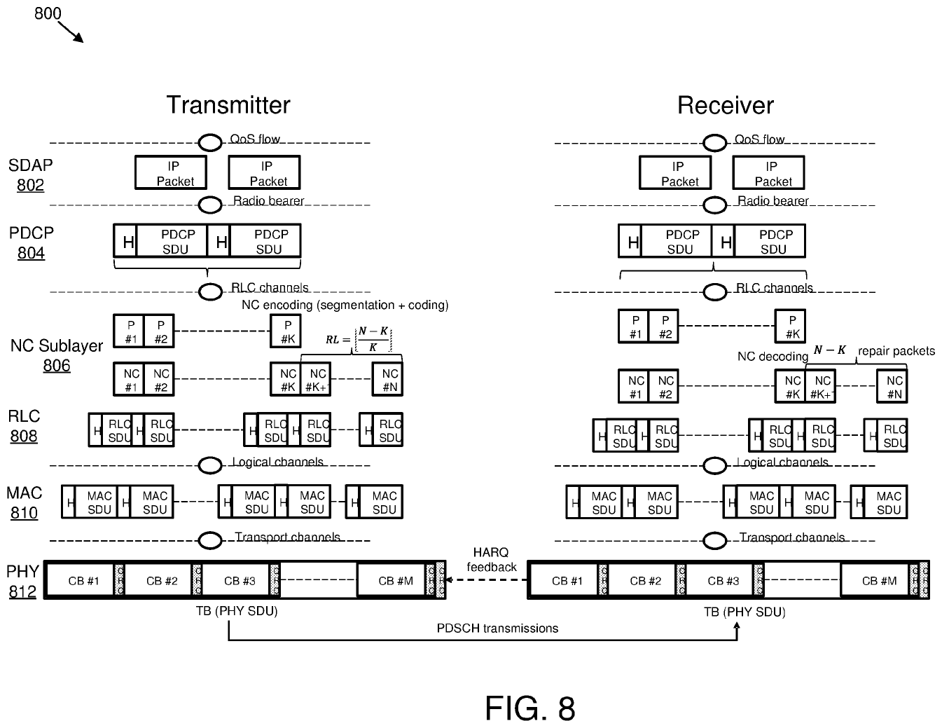

In certain embodiments, there may be a protocol stack as shown in FIG. 8, wherein the NC is enabled with HARQ process configurations and processing.

FIG. 8 is a schematic block diagram illustrating one embodiment of integration of timing 800 of RAN and/or UE protocol stacks for an application serving DL traffic (e.g., XR and/or CGM) with NC sublayer enabled and HARQ feedback reports. The timing 800 shows SDAP 802, PDCP 804, NC sublayer 806, RLC 808, MAC 810, and PHY 812.

In a first embodiment a UE: 1) is signaled with an NC configuration by a gNB serving a scheduled network-coded ADU; 2) determines, for each one or more scheduled TBs of the scheduled network-coded ADU, a threshold of necessary minimum number of correctly received CBs based on at least the NC configuration; 3) configuring one or more NC-aware HARQ processes with the determined threshold of necessary minimum number of correctly received CBs for each of the one or more TBs of the scheduled network-coded ADU; 4) determining for each NC-aware HARQ processes associated with each TB of the scheduled network-coded ADU an acknowledgement (“ACK”) if the number of CBs within a TB correctly decoded post FEC decoding is at least equal to the determined threshold of necessary minimum number of correctly received CBs of that TB, and a non-acknowledgement (“NACK”) otherwise, as a NC-aware HARQ ACK/NACK; and/or 5) feeding back the NC-aware HARQ ACK/NACK and the HARQ quality report information bits as an NC-aware HARQ feedback to the gNB.

In a second embodiment a gNB: 1) determines a NC configuration to be applied for encoding a network-coded ADU traffic for transmission; 2) determines a CB threshold to meet for successful NC decoding and error recovery; 3) signals the NC configuration and the determined CB threshold to a UE; 4) schedules the network-coded ADU traffic for transmission to the UE; 5) receives an NC-aware HARQ feedback from the UE; and/or 6) applies the NC-aware HARQ feedback to determine necessary retransmissions of network-coded data necessary for error correction.

In an example, the gNB serving XR or CGM DL traffic to the UE indicates to the latter the configuration of the NC sub-layer by means of: 1) semi-static RRC signaling procedures; 2) dynamic signaling through DCI scheduling of PDSCH data traffic instances; and/or 3) dynamic signaling through DCI scheduling of group PDSCH data traffic instances.

In some examples, the indication of the NC configuration may contain information detailing at least one of a NC codebook type (e.g., Reed-Solomon, Raptor RFC 5053, RaptorQ RFC 6330, Random Linear NC, etc.), a NC packet (or symbol) size, a NC information transmissions size, a NC information packets number, a network-coded repair packets number, a NC maximum transmission size, and/or an NC redundancy level (e.g., determined either as a ratio of information packets number to network-coded packets number, as a ratio of network-coded repair packets number to information packets number, or as a scalar number of network-coded repair packets).

In one example, based on the received NC configuration, the UE determines the NC redundancy level and error recovery characteristics. Using this determined information and the existing higher layers configured TB size (“TBS”), MCS, and DCI indicated scheduling, the UE further determines the necessary minimum number of CBs to be received correctly out of a TB post FEC decoding required for correctly receiving the transmission at the higher NC sublayer post NC decoding.

For a further example, consider a singular radio bearer DL transmission with a TBS of 100,000 bits to be transmitted over a TB with CBs configured to use low-density parity-check (“LDPC”) FEC Base Graph 1, such that 12 CBs of size 8357 bits are information carrying (e.g., including cyclic redundancy check (“CRC”) information) and transmitted over a transmission time interval (“TTI”), wherein network-coded packets are uniformly spread. In such conditions, for N=95 network-coded packets of size 1,024 bits (e.g., 128 bytes) each (e.g., corresponding to K=73 information packets of 1.024 bits each coded with a redundancy level RL=30%), it follows that at least

$$10 = ⌈ 12 \cdot \frac{73}{95} ⌉$$

CBs need to be received correctly post-FEC decoding at the PHY layer for an NC code (e.g., RaptorQ code) to be able to recover with very high probability

$$( e . g . , 1 - \frac{1}{25 {6}^{1 + 2}} > 99.9999 \% )$$

the intended transmitted information post NC decoding. This results in allowing for 2 CBs to be erroneous by means of NC added redundancy.

In another example, an NC-aware HARQ process monitoring the receiving of a network-coded TB applies the determined threshold of necessary minimum number of correctly received CBs to determine whether the TB information can be recovered at higher layers after NC decoding. The determination of correctly received CB data post FEC decoding is done by CRC. As such, in some examples, the data that failed a CRC within a CB is considered invalid and is marked accordingly for skipping processing at higher layers, e.g., to be discarded at MAC layer. In one example, as the MAC PDUs encapsulating the network-coded packets may not be aligned to the CB boundaries within a TB, the MAC layer identifies portions of incomplete (or corrupted) MAC PDUs based on the corrupted CBs and available NC configuration. Therefore, an incomplete MAC PDU is a PDU at the MAC level which contains a non-void partition of erroneously received bits. Thus, the MAC demultiplexes to the upper layer's logical channels just the detected valid MAC PDUs and skips the incomplete MAC PDUs. As a consequence, at the RLC layer only the valid (e.g., syntactically correct network-coded RLC PDUs), are processed. The latter are processed by the NC sublayer during decoding and given that the minimum number of required packets for reconstruction, N′≥K, have been received the original information is completely recovered.

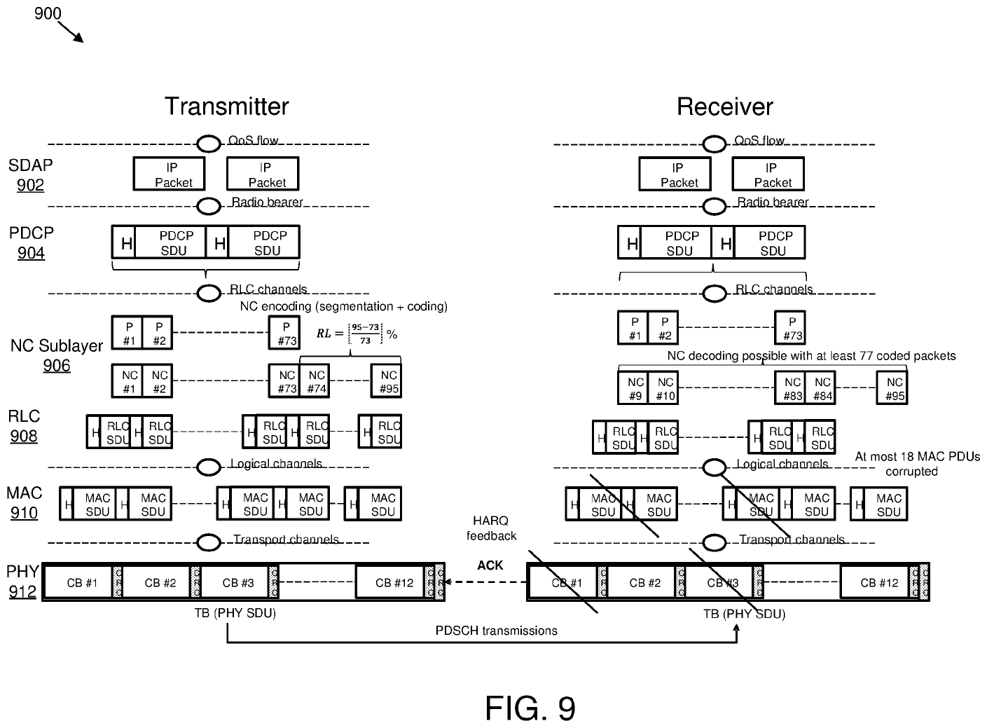

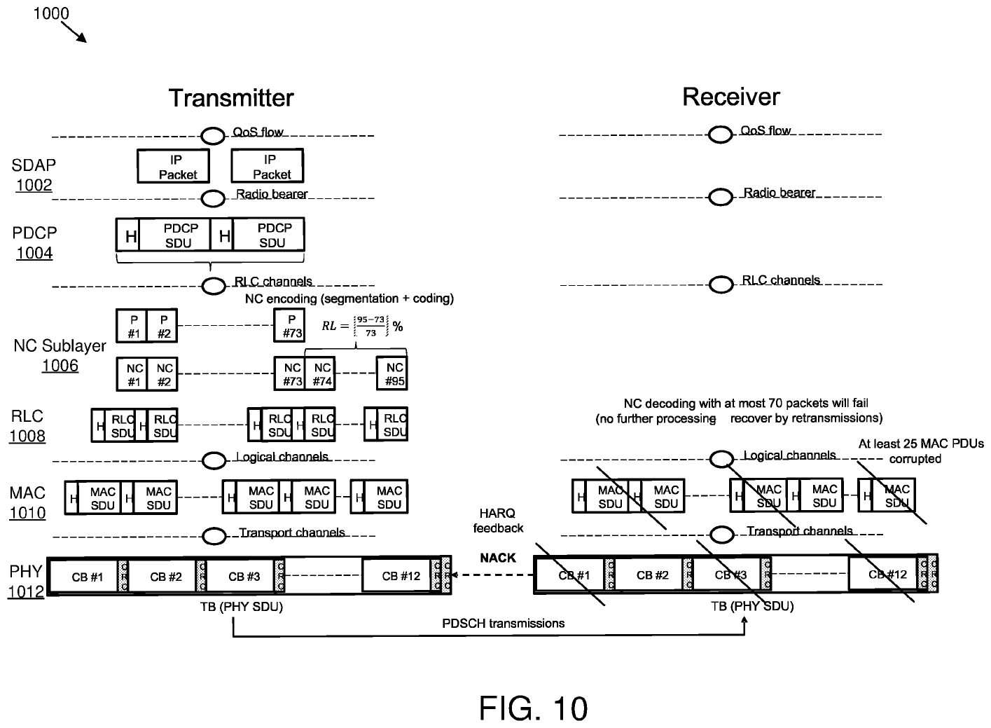

A schematic of a procedure for the above example and numerology is illustrated in FIG. 9 for the case where 2 CBs are corrupted resulting in at most 18 MAC PDUs being dropped, yet NC decoding providing enough redundancy (i.e., N−K=22 recovery packets) for recovery of original data at higher layers, which results in a HARQ ACK feedback. On the other hand, in FIG. 10 the case where 3 CBs are corrupted is presented whereby at least 25 MAC PDUs would be dropped at the MAC level, yielding data recovery by NC decoding impossible given the redundancy level set, and as such the HARQ NACK feedback is signaled.

It should be noted that NC-aware HARQ ACK is signaled even in scenarios where not all the CBs of the TB are received correctly, if the number of correctly received CBs does reach or exceed the necessary minimum number of correctly received CB threshold for the NC decoding to recover lost and corrupted data packets. Furthermore, via HARQ signaling, the latency of ACK and/or NACK feedback may be decreased well under a radio frame duration (e.g., 1-10 ms) for fast signaling of failures as necessary for high-rate low-latency quasi-periodic communications such as for XR applications.

FIG. 9 is a schematic block diagram illustrating one embodiment of timing 900 of network-coded transmissions with HARQ-ACK feedback upon receiving a TB with some erroneous CBs less than a determined threshold based on the NC redundancy level. The timing 900 shows SDAP 902, PDCP 904, NC sublayer 906, RLC 808, MAC 910, and PHY 912.

FIG. 10 is a schematic block diagram illustrating one embodiment of timing 1000 of network-coded transmissions with HARQ-NACK feedback upon receiving a TB with some erroneous CBs more than a determined threshold based on the NC redundancy level. The timing 1000 shows SDAP 1002, PDCP 1004, NC sublayer 1006, RLC 1008, MAC 1010, and PHY 1012.

In some examples, the NC-aware HARQ feedback is explicitly enabled by a configuration field within at least one of semi-static RRC signaling, protocol data control channel (“PDCCH”) DCI signaling, PDCCH DCI scheduling of one or more PUSCH and/or PDSCH transmissions. In other examples, the NC-aware HARQ feedback is enabled by implicitly signaling a valid NC configuration by at least one of semi-static RRC signaling, and dynamic DCI signaling for scheduling one or more PDSCH transmissions. In one example, the NC-aware HARQ feedback may be completely disabled and no feedback signaling is to be performed, and the disablement of the NC-aware HARQ feedback is performed by at least one of semi-static RRC signaling, and dynamic DCI signaling for scheduling one or more PDSCH transmissions.

In an example, if TBS of a TB is smaller than a threshold, the NC-aware HARQ feedback is not provided. For instance, regular HARQ-ACK is provided for the TB. In other examples, no HARQ-ACK feedback is provided for a TB. In another example, the NC-aware HARQ feedback is multiplexed in a HARQ-ACK codebook that is different than the HARQ-ACK codebook associated with non-NC-aware HARQ feedback.

In certain embodiments, 5G NR allows for RRC configuration of CBG retransmissions indicated by means of DCI signaling by means of the CBGTI and CBGFI fields, e.g., in DCI format 1_1. CBG based retransmissions rely on grouping CBs of large TBs into CBGs uniformly according to the RRC PDSCH-CodeBlockGroup Transmission configuration parameter. The CBG retransmissions improve the spectral efficiency of the HARQ mechanism by reducing the amount of retransmission data to the CBGs where CBs have been erroneously received rather than retransmitting the TB as per the default procedure.

In some embodiments, where CBG-based retransmissions are enabled given a valid RRC configuration and DCI scheduling of PDSCH transmissions, the NC-aware HARQ feedback previously specified is enhanced to produce multibit HARQ ACK/NACK feedback providing an ACK/NACK feedback bit per unit of CBG spanning the received TB. In such embodiments, the CBG-based retransmissions influence just the partitions of the TB that are to be retransmitted for recovery of the data at the PHY level and they are thus to be prioritized based on the NC awareness of the monitoring HARQ process.

In one example, where CBG-based retransmissions are enabled and the total amount of correctly received CBs did reach the NC-aware necessary minimum number of correctly received CBs threshold, the HARQ process will report a HARQ-ACK bit for each of the CBGs regardless of any CB errors enclosed within the individual CBs. In such scenarios no retransmissions are necessary.

In another example, where CBG-based retransmissions are enabled and the total amount of correctly received CBs did not reach the NC-aware necessary minimum number of correctly received CBs threshold, the HARQ process will rank the CBGs based on the enclosed number of CB errors and accordingly ACK/NACK them given the existing NC configuration. Concretely, in such embodiments the procedure follows the steps: 1) if the total number of correct CBs is lower than the NC-aware minimum number of correctly received CBs threshold, then: a) the NC-aware HARQ process sorts in descending order the CBGs given the number of CB errors they each contain in the TB receive buffer, b) the top ranked one or more CBGs whose number of erroneous CBs that could be corrected via retransmissions and would increase the total number of correct CBs in the TB receive buffer to an equal or above level to the necessary minimum number of correctly received CBs threshold are marked as NACK, c) the rest of CBGs in the TB are marked as ACK, c) the obtained NC-aware HARQ feedback is multiplexed according to the CBG-based HARQ codebook and transmitted to the transmitter, d) the HARQ process receives from the transmitter the retransmitted CBGs and processes the latter updating the total number of correct CBs in the TB receive buffer, e) if the total number of correct CBs is greater or equal than the NC-aware minimum number of correctly received CBs threshold, then: the HARQ process completes with all CBGs being acknowledged, otherwise, the process repeats steps 1.a-1.e; 2) otherwise: the HARQ process completes with all CBGs being acknowledged.

In one example, the case of FIG. 10 is reconsidered whereby the CBG-based transmissions have been enabled such that the 12 CBs are grouped within 4 CBGs each containing of 3 CBs. Upon an initial transmission, CBG #1 and CBG #4 are received with errors such that 3 CBs are erroneous (e.g., 2 CBs in CBG #1 and 1 CB in CBG #4), respectively. In this example, the NC-aware HARQ process determines that the 3 erroneous CBs prevent recovery by NC decoding given the existing NC configuration and applies the procedure specified above. The sorting operation results in the Table 3.

TABLE 3
Ranking example of CBGs for retransmission based
on descending sorting of enclosed CB errors.

| CBG ranking for | Number of erroneous | |
|---|---|---|
| retransmission | CBs | CBG identifier |
| 1 | 2 | 1 |
| 2 | 1 | 4 |
| 3 | 0 | 2 |
| 4 | 0 | 3 |

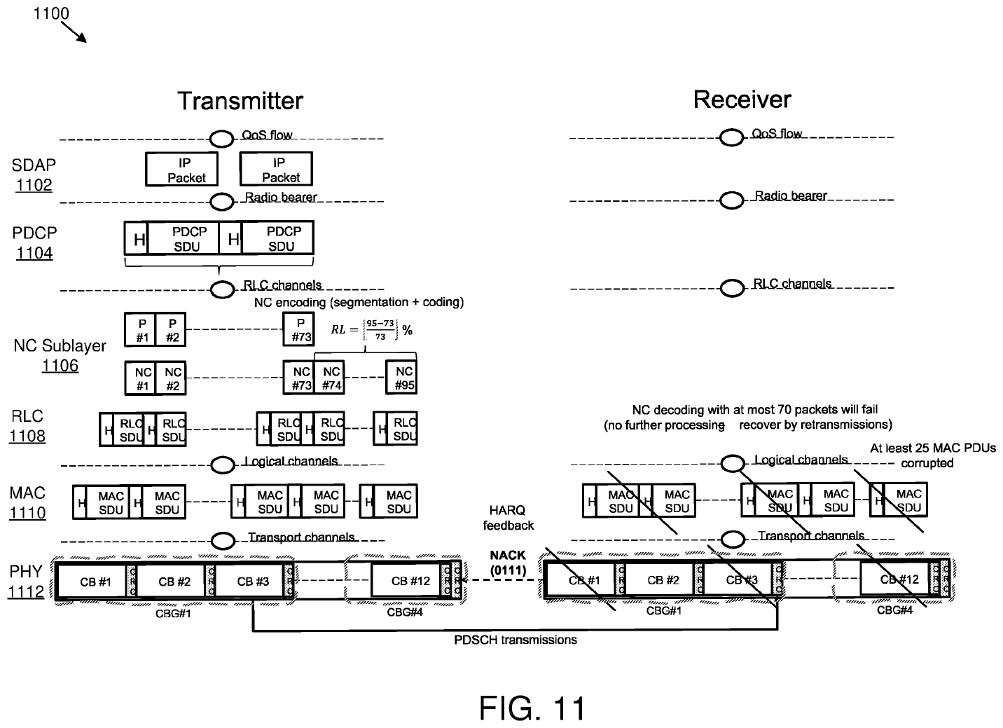

In various embodiments, based on the latter sorting, the HARQ process determines that retransmission of CBG #1 with 2 erroneous CBs would be sufficient to recover enough data for NC decoding to succeed. As such, the HARQ NACK feedback tuple (e.g., NACK, ACK, ACK, ACK) is signaled to the transmitter as illustrated in FIG. 11. The HARQ entity in the transmitter schedules the retransmission of CBG #1 in response to the HARQ NACK feedback.

FIG. 11 is a schematic block diagram illustrating one embodiment of timing 1100 of CBG-based retransmission with proposed NC-aware HARQ process monitoring procedure (e.g., initial transmission). The timing 1100 shows SDAP 1102, PDCP 1104, NC sublayer 1106, RLC 1108, MAC 1110, and PHY 1112.

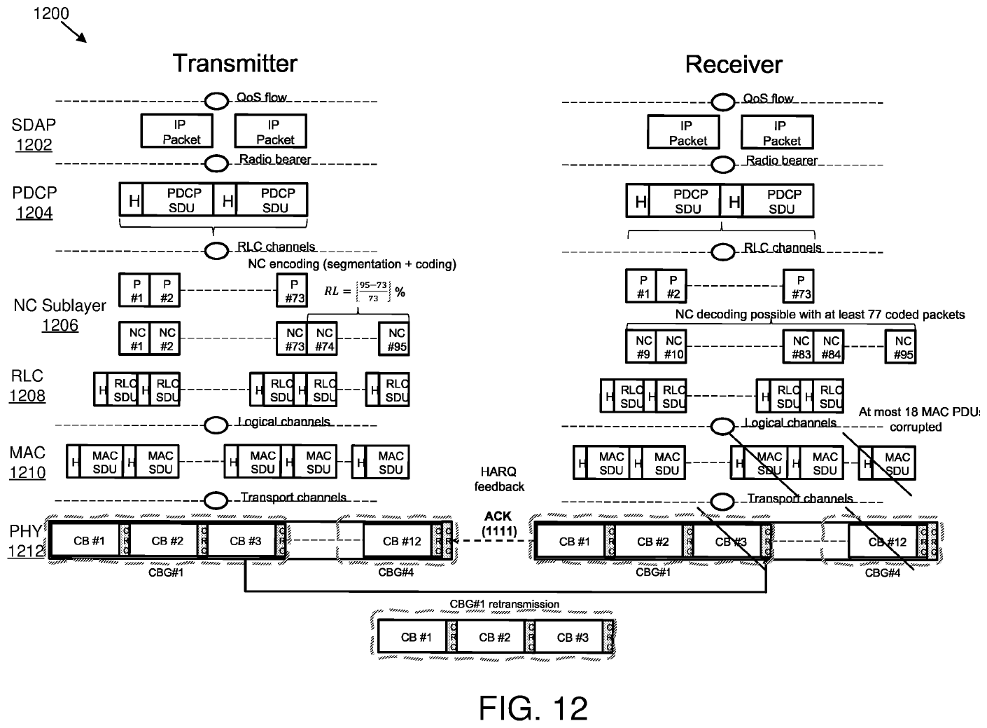

FIG. 12 is a schematic block diagram illustrating one embodiment of timing 1200 of CBG-based retransmission with proposed NC-aware HARQ process monitoring procedure (e.g., CBG #1 retransmission). The timing 1200 shows SDAP 1202, PDCP 1204, NC sublayer 1206, RLC 1208, MAC 1210, and PHY 1212.

In an example, 1 CB is received with errors upon retransmission of the CBG #1 while the other 2 CBs are received correctly, as outlined in FIG. 12. As such the NC-aware HARQ process determines that enough correct data has been received to recover the original packets post NC decoding and acknowledges the latter with HARQ ACK feedback (e.g., ACK, ACK, ACK, ACK) across all CBGs. Therefore, despite receiving 2 CBs with errors, the CBG-based retransmissions with NC-aware HARQ recovers network-coded data efficiently by retransmission of only necessary CBG resources increasing spectral efficiency and decreasing latency of the HARQ retransmission procedure.

In various embodiments, a necessary minimum number of correctly received CBs threshold is computed as a tuple of scalar values. One value determines the minimum number of correctly received CBs threshold for the existing NC, MCS, and TBS configuration assuming that the CB errors are spread across a series of consecutive CBs (e.g., best-case scenario). The second value determines the necessary minimum number of correctly received CBs threshold for the existing NC, MCS, and TBS configuration assuming that the CB errors are spread across a series of non-consecutive CBs (e.g., worst-case scenario). In one example, the minimum number of correctly received CBs threshold tuple may be reduced to a singular scalar value selected as the determined minimum number of correctly received CBs threshold for the worst-case scenario.

In some examples, the network-coded packets are not aligned with the PHY level CBs and as such a network-coded packet may be spanning one or more CBs. This fact determines the average number of network-coded packets per CB as shown in Equation 3, where the CBS denotes the CB size in bits and NCS denotes the network-coded packets size in bits. Note that in an example implementation for 5G NR, the CBS may also be defined in terms of the TBS following the 5G NR specification for CB segmentation and concatenation determining the number of CBs and size thereof.

$$PpCB = ⌈ \frac{CBS}{NCS} ⌉ \qquad Equation 3$$

In addition, as errors at the CB level may happen either in colocation (e.g., in consecutive CBs), or sporadically (e.g., in non-consecutive CBs), the average number of erroneous network-coded packets for nCBₑᵣᵣ^{consecutive} consecutive CBs have been erroneously received (e.g., the CRC check has failed) is given by Equation 4.

$${nNC}_{err}^{consecutive} = ⌈ \frac{CBS}{NCS} \cdot {nCB}_{err}^{consecutive} ⌉ , \qquad Equation 4$$

For nCBₑᵣᵣ^{nonconsecutive} non-consecutive CBs (e.g., an erroneous CB that contains at least one or more correct CBs received between itself and any adjacent erroneous CB) the average number of erroneous network-coded packets is given by Equation 5.

$${nNC}_{err}^{nonconsecutive} = ⌈ \frac{CBS}{NCS} ⌉ \cdot {nCB}_{err}^{nonconsecutive} . \qquad Equation 5$$

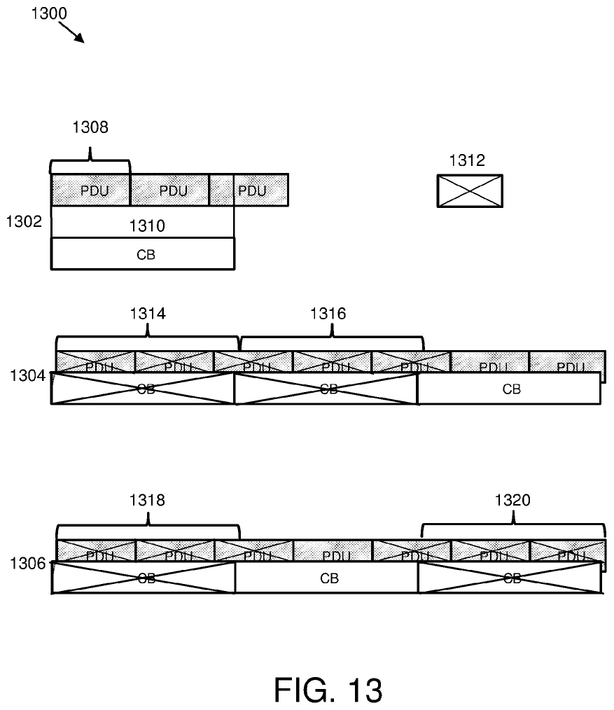

FIG. 13 is a schematic block diagram illustrating one embodiment of timing 1300 of consecutive and non-consecutive CB errors and a mapping to network-coded packets. A baseline timing 1302 is illustrated, as well as a timing 1304 with consecutive CB errors, and a timing 1306 with non-consecutive CB errors. For the baseline timing 1302, a network-coded PDU 1308 is illustrated, and a timing 1310 of 2.33 PDU units in 1 CB. Also illustrated is an example of a corrupted packet and/or block 1312. The timing 1304 includes a first timing 1314 in which 2.33 PDUs are corrupted and a second timing 1316 in which 2.33 PDUs are corrupted (e.g., 4.66 PDUs corrupted with no double counting for a total of 5 PDUs corrupted). Moreover, the timing 1306 includes a first timing 1318 in which 3 PDUs are corrupted and a second timing 1320 in which 3 PDUs are corrupted (e.g., 6 PDUs corrupted with no PDU overlapping for a total of 6 PDUs corrupted). Specifically, FIG. 13 illustrates why the separation between consecutive and non-consecutive CBs is of relevance for the counting problem related to the determination of the necessary minimum number of correctly received CBs threshold for a CB. In one example, as displayed, 1 CB may fit 2.33 parts of a network-coded packet. In an example where 2 consecutive CBs are erroneously received, a total 4.66 parts of a network-coded packet would be corrupted, resulting into an integer total number of 5 network-coded packets to be corrupted. In another example, where 2 non-consecutive CBs are erroneously received, each CB error corrupts 2.33 parts of a network-coded packet leading to corrupting individually 3 network-coded packets each, resulting in a total number of 6 network-coded packets to be corrupted.

In one example, the total number of network-coded errors based on the number of erroneous CBs is obtained as the sum of the expressions from Equation 4 and Equation 5 as shown in FIG. 6.

$${nNC}_{err}^{total} = {nNC}_{err}^{consecutive} + {nNC}_{err}^{nonconsecutive} , \qquad Equation 6$$

To guarantee recovery with high probability given NC, the condition is shown in Equation 7 or Equation 8, expressed in terms of N (e.g., the total number of network-coded packets), and RL %, i.e., the redundancy level of the NC code configuration, rather than N and K (e.g., the total number of information source packets).

$$N - K \geq {nNC}_{err}^{total} , \qquad Equation 7$$

$$⌈ ⌊ \frac{N}{1 + \frac{RL \%}{100}} ⌋ \cdot \frac{RL \%}{100} ⌉ \geq {nNC}_{err}^{total} , \qquad Equation 8$$

In some embodiments, as the errors may be both consecutive and non-consecutive among the CBs, it follows that nNCₑᵣᵣ^{consecutive}≤nNCₑᵣᵣ^{total}≤nNCₑᵣᵣ^{nonconsecutive} and the amount of erroneous CBs tolerated nCBₑᵣᵣ^{tolerated} is as shown in Equation 9.

$${nCB}_{err , max}^{nonconsecutive} \leq {nCB}_{err}^{tolerated} \leq {nCB}_{err , mαx}^{consecutive} , \qquad Equation 9$$

Where nCB_{err,max}^{consecutive} denotes the maximum integer number of CB consecutive errors possible satisfying Equation 4, Equation 6, and Equation 8 if number of non-consecutive errors is fixed to 0 (i.e., all CB errors are considered to be of consecutive CBs), and, similarly, nCB_{err,max}^{nonconsecutive} denotes the maximum integer number of CB non-consecutive errors possible satisfying Equation 5, Equation 6, and Equation 8 if a number of consecutive CB errors is fixed to 0 (i.e., all CB errors are considered to be of non-consecutive CBs). The necessary minimum number of correctly received CBs threshold is determined as the tuple (nCB−nCB_{err,max}^{consecutive}, nCB−nCB_{err,max}^{nonconsecutive}) such as that in Equation 10, with nCB denoting the total number of CBs within the transmitted TB. Alternatively, the same information of the threshold is expressed, in another example, as the tolerated maximum number of CB errors threshold tuple (nCB_{err,max}^{nonconsecutive}, nCB_{err,max}^{consecutive}), according to Equation 9.

$$nCB - {nCB}_{err , mαx}^{consecutive} \leq {nCB}_{correct}^{necessary} \leq nCB - {nNC}_{err , max}^{nonconsecutive} , \qquad Equation 10$$

In various embodiments, for a network-coded plurality of packets as described herein, concepts of a necessary minimum number of correctly received CBs threshold and of a tolerated maximum number of CB errors are analogous and reciprocal. Therefore, any determination procedures and signaling indications may be applicable to both concepts.

In one example, illustrated in FIG. 10, 3 CBs are received with errors out of the total of 12 CBs, which leads to the corruption (e.g., later erasure) of at least 25 network-coded packets, if all errors where consecutive, and at most 27 network-coded packets, if all errors where to be non-consecutive, respectively. In this example, the determined maximum tolerated number of errors for both type of errors considered exclusively is of 2 CBs at the PHY level, according to Equation 9, and as such the 9 CBs received correctly do not reach the minimum number of correctly received CBs threshold determined of 10 CBs, according to Equation 10, and a HARQ-NACK is fed back to the transmitter.

In another example, illustrated in FIG. 9, 2 CBs are received with errors out of the total of 12 CBs, which leads to the corruption (e.g., later erasure) of at least 17 network-coded packets, if errors where consecutive, and at most 18 network-coded packets, if errors where to be non-consecutive, respectively. In this example, the determined maximum tolerated number of errors for both type of errors considered exclusively is of 2 CBs at the PHY level, according to Equation 9, and as such the 10 CBs received correctly reach the minimum number of correctly received CBs threshold determined of 10 CBs, according to Equation 10, and a HARQ-ACK is fed back to the transmitter.

In one embodiment, determination of a necessary minimum number of correctly received CBs threshold is done at a gNB based on the configured RRC, NC, and MCS parameters. The latter are used by the gNB to extract necessary information of the TBS, CB size (“CBS”), and network-coded packet size (“NCS”) applicable for a TB during a TTI and therefore to explicitly determine the necessary minimum number of correctly received CBs threshold with TB granularity applicable to the next scheduled TTI. The determined threshold is, in some examples, accordingly indicated to the UE that will receive and process the scheduled TB by a bit field indication over at least one of a semi-static RRC signaling, and a dynamic DCI scheduling of one or more PDSCH transmissions.

In some examples, a bit field indication transmitted by the network to the UE encoding the threshold for NC-aware HARQ is formed of: 1) a necessary minimum number of correctly received CBs threshold tuple (nCB−nCB_{err,max}^{consecutive}, nCB−nCB_{err,max}^{nonconsecutive}); 2) a tolerated maximum number of CB errors threshold tuple (nCB_{err,max}^{nonconsecutive}, nCB_{err,max}^{consecutive}); 3) a minimum number of correctly received CBs threshold scalar as nCB_{correct}^{necessary}=max(nCB−nCB_{err,max}^{consecutive}, nCB−nCB_{err,max}^{nonconsecutive}); and/or 4) a tolerated maximum number of CB errors threshold scalar as nCBₑᵣᵣ^{tolerated}=min(nCB_{err,max}^{nonconsecutive}, nCB_{err,max}^{consecutive}).

In one example, a bit field indication of a length of an NC-aware HARQ necessary minimum number of correctly received CBs threshold (or alternatively of the tolerated maximum number of CB errors threshold) is dynamically signaled as encoding either ┌log₂(a)+log₂(b)┐ bits for tuple threshold of (a, b), or a number of ┌log₂(a)┐ bits for a scalar threshold of numeric value a. In another example, the bit field indication length may be semi-statically fixed by upper layer RRC signaling describing an indexed tabular encoding of threshold possible values, whereby the bit field indication carries the index of the associated threshold value for reducing the signaling length.

In another embodiment, the determination of the necessary minimum number of correctly received CBs threshold is done by the UE based on the configured RRC, NC, and MCS parameters whereby at least two of the number of network-coded packets, NC redundancy level, and the number of source data packets to undergo NC are used such that at least one of the following steps are performed: 1) determine an average number of network-coded packets per unit of CB of a TB with nCB CBs; 2) determine a necessary minimum number of correctly received CBs scalar threshold, nCB−nCB_{err,max}^{consecutive}, given the NC parameters configuration considering only consecutive CB errors; 3) determine a necessary minimum correctly received CBs scalar threshold, nCB−nCB_{err,max}^{nonconsecutive}, given the NC parameters configuration considering only non-consecutive CB errors; 4) determine a necessary minimum number of correctly received CBs threshold as a tuple of two, (nCB−nCB_{err,max}^{consecutive}, nCB−nCB_{err,max}^{nonconsecutive}), formed of the necessary minimum number of correctly received CBs scalar threshold considering all erroneous CBs to be consecutive, and of the necessary minimum number of correctly received CBs scalar threshold considering all erroneous CBs to be non-consecutive; and/or 5) optionally compress the determined necessary minimum number of correctly received CBs threshold tuple of two to a singular scalar necessary minimum number of correctly received CBs threshold as nCB_{correct}^{necessary}=max(nCB−nCB_{err,max}^{consecutive}, nCB−nCB_{err,max}^{nonconsecutive}). HARQ entity, processes, and procedures.

In certain embodiment, HARQ feedback is binary in the form of ACK/NACK with reporting done per instance of HARQ process corresponding to 1 TB or 2 TBs (in case of spatial multiplexing with more than 4 layers). The HARQ procedure is controlled by a HARQ process within the HARQ entity of a ServiceCell as part of the MAC entity. The following procedure follows: 1) the MAC entity includes a HARQ entity for each serving cell, which maintains a number of parallel HARQ processes—each HARQ process is associated with a HARQ process identifier—the HARQ entity directs HARQ information and associated TBs received on the DL shared channel (“SCH”) (“DL-SCH”) to the corresponding HARQ processes; 2) the number of parallel DL HARQ processes per HARQ entity is specified—the dedicated broadcast HARQ process is used for broadcast control channel (“BCCH”)—the HARQ process supports one TB when the physical layer is not configured for downlink spatial multiplexing—the HARQ process supports one or two TBs when the physical layer is configured for downlink spatial multiplexing; and/or 3) if the MAC entity is configured with pdsch-AggregationFactor>1, the parameter pdsch-AggregationFactor provides the number of transmissions of a TB within a bundle of the downlink assignment. Bundling operation relies on the HARQ entity for invoking the same HARQ process for each transmission that is part of the same bundle. After the initial transmission, pdsch-AggregationFactor−1 HARQ retransmissions follow within a bundle.

The MAC entity shall:
1> if a downlink assignment has been indicated:
2> allocate the TB(s) received from the physical layer and the associated HARQ information to the HARQ process indicated by the associated HARQ information.
1> if a downlink assignment has been indicated for the broadcast HARQ process:
2> allocate the received TB to the broadcast HARQ process.

When a transmission takes place for the HARQ process, one or two (in case of downlink spatial multiplexing) TBs and the associated HARQ information are received from the HARQ entity.

For each received TB and associated HARQ information, the HARQ process shall:
1> if the NDI, when provided, has been toggled compared to the value of the previous received transmission corresponding to this TB; or
1> if the HARQ process is equal to the broadcast process, and this is the first received transmission for the TB according to the system information schedule indicated by RRC; or
1> if this is the very first received transmission for this TB (i.e. there is no previous new data indicator (“NDI”) for this TB):
2> consider this transmission to be a new transmission.
1> else:
2> consider this transmission to be a retransmission.

The MAC entity then shall:
1> if this is a new transmission:
2> attempt to decode the received data.
1> else if this is a retransmission:
2> if the data for this TB has not yet been successfully decoded:
3> instruct the physical layer to combine the received data with the data currently in the soft buffer for this TB and attempt to decode the combined data.
1> if the data which the MAC entity attempted to decode was successfully decoded for this TB; or
1> if the data for this TB was successfully decoded before:
2> if the HARQ process is equal to the broadcast process:
3> deliver the decoded MAC PDU to upper layers.
2> else if this is the first successful decoding of the data for this TB:
3> deliver the decoded MAC PDU to the disassembly and demultiplexing entity.
1> else:
2> instruct the physical layer to replace the data in the soft buffer for this TB with the data which the MAC entity attempted to decode.
1> if the HARQ process is associated with a transmission indicated with a Temporary cell (“C”) radio network temporary identifier (“RNTI”) (“C-RNTI”) and the Contention Resolution is not yet successful (see clause 5.1.5); or
1> if the HARQ process is associated with a transmission indicated with a message B (“MSGB”) RNTI (“MSGB-RNTI”) and the Random Access procedure is not yet successfully completed (see clause 5.1.4a); or
1> if the HARQ process is equal to the broadcast process; or
1> if the timeAlignmentTimer, associated with the TAG containing the Serving Cell on which the HARQ feedback is to be transmitted, is stopped or expired:
2> not instruct the physical layer to generate acknowledgement(s) of the data in this TB.
1> else:
2> instruct the physical layer to generate acknowledgement(s) of the data in this TB.

The MAC entity shall ignore NDI received in all downlink assignments on PDCCH for its Temporary C-RNTI when determining if NDI on PDCCH for its C-RNTI has been toggled compared to the value in the previous transmission.

It should be noted that, if the MAC entity receives a retransmission with a TB size different from the last TB size signaled for this TB, the UE behavior is left up to UE implementation.

In certain embodiments, HARQ enabling and/or disabling for DL transmissions has been considered for delay-sensitive wireless links. The non-terrestrial networks (“NTN”) problem of increased delay given the round trip time (“RTT”) incurred over the satellite links.

In some embodiments, if UL HARQ feedback is disabled, there could be issues if: 1) MAC CE and RRC signaling are not received by UE; 2) DL packets are not correctly received by UE for a long period of time without gNB knowing it.

The following may be used for NTN if HARQ feedback is disabled: 1) indicate HARQ disabling via DCI in a new and/or re-interpreted field; 2) new uplink control information (“UCI”) feedback for reporting DL transmission disruption and or requesting DL scheduling changes.

The following possible enhancements for slot-aggregation or blind repetitions may be considered for NTN: 1) greater than 8 slot-aggregation; 2) time-interleaved slot aggregation; and/or 3) new MCS table.

In various embodiments, HARQ ACK/NACK reporting for DL transmissions may be multiplexed over UCI and transported over physical uplink control channel (“PUCCH”) or PUSCH. The encoding of HARQ ACK/NACK may be organized in codebooks, such as: 1) Type-1 HARQ-ACK codebook (e.g., Semi-static)-a semi-static codebook determined by the RRC configuration of HARQ timing offset, CBG-based HARQ, CCs or simultaneous TBs in transit and dynamic scheduling decisions—the number of bits to send in an ACK/NACK report is thus fixed and could be potentially large-if many component carriers are configured for instance but only a few are scheduled, this is inefficient; 2) Type-2 HARQ-ACK codebook (e.g., Dynamic)—a dynamic codebook or enhanced dynamic codebook, optimized to reduce multiplexed feedback size since the UE sends feedback only for the scheduled carriers—as in low SINR channel conditions, UE may wrongly infer the number of carriers that were scheduled, downlink assignment index as a tuple of a counter DAI (“cDAI”) and a total DAI (“tDAI”) (e.g., cDAI, tDAI) is used as part of DCI scheduling to aid the UE determine and form the dynamic HARQ feedback codebook; 3) Type-3 HARQ-ACK codebook (e.g., OneShotReporting)—the UE sends ACK/NACK report for all HARQ processes and all CCs configured in the PUCCH group in a semi-static manner given RRC configuration and parameters; and/or 4) for CBG-based HARQ-ACK codebook (e.g., CBG-level reporting), whereby the reporting is done on a per CBG level as part of the TB given an RRC configured HARQ-ACK CBG-based feedback.

In certain embodiments, HARQ may be used for multimedia services.

In some embodiments, multimedia broadcast and multicast services (“MBMS”) enhance their reliability with various HARQ feedback mechanisms.

In various embodiments, unlike LTE eMBMS and single-cell point-to-multipoint (“SC-PTM”), HARQ-ACK feedback and HARQ retransmissions are supported to achieve high reliability for multicast mode. HARQ-ACK feedback is required for gNB to know UE's reception status and perform the retransmission. However, feedback resource in PUCCH may be overloaded when many UEs are served for a multicast session. Moreover, a criterion of retransmission could be failure of reception at one UE. Based on these factors, configuration flexibility of HARQ-ACK feedback options is allowed as follows: 1) ACK/NACK based HARQ-ACK feedback: UE feedbacks ACK or NACK over a UE dedicated PUCCH resources—this mechanism may be efficient if the number of UEs receiving the multicast data is small; 2) NACK only based HARQ-ACK feedback: UE feedbacks only NACK over common PUCCH resources shared with other UEs in same group—this mechanism is resource efficient but gNB cannot detect the case that the UE fails decoding of PDCCH information; and/or 3) no HARQ-ACK feedback: UE does not send any feedback for received data. When the QoS requirement for the multicast data for UE is low, gNB can use this option to save the PUCCH resource. gNB can dynamically switch between ACK/NACK based HARQ-ACK feedback and No HARQ-ACK feedback by RRC signaling or DCI.

In certain embodiments, the RLC layer has 3 modes of operations and each with a specific PDU as follows: 1) transparent mode (“TM”), where the RLC is completely transparent and is essentially bypassed-no retransmissions, no duplicate detection, and no segmentation and/or reassembly take place-retransmissions are not feasible for these channels as there is no possibility for the device to feedback status reports as no uplink has been established; 2) unacknowledged mode (“UM”) supports segmentation but not retransmissions—this mode is used when error-free delivery is not required (e.g., voice-over IP); and/or 3) acknowledged mode (“AM”) is the main mode of operation for the DL-SCH and UL-SCH. Segmentation, duplicate removal, and retransmissions of erroneous data may all be supported.

In some embodiments, an RLC ARQ procedure is enabled only in AM operation and relies on retransmissions upon receival of RLC status reports indicating from a receiver side the failure to receive an RLC PDU based on the RLC sequence numbering. The triggering of RLC status reports is determined by a transmitter by explicit polling or by a receiver by event-based detection of misreception.

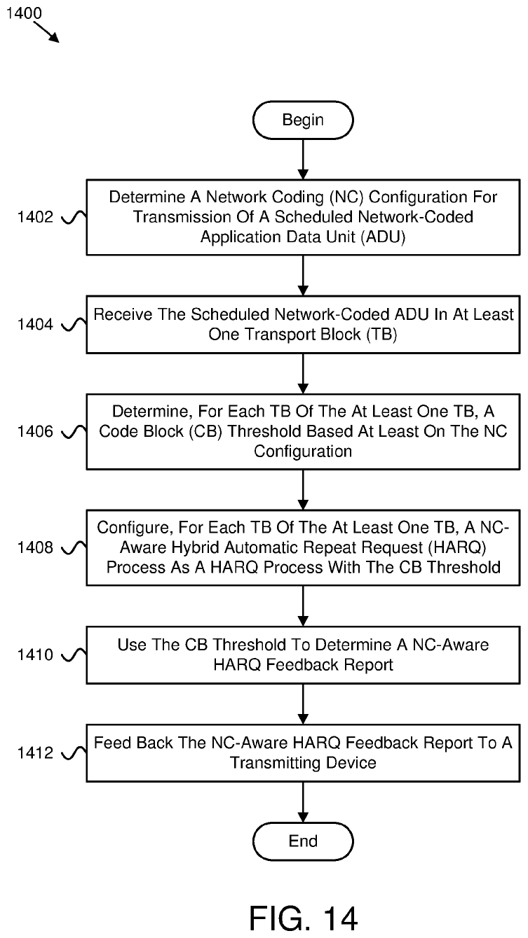

FIG. 14 is a flow chart diagram illustrating one embodiment of a method 1400 for configuring based on NC. In some embodiments, the method 1400 is performed by an apparatus, such as the remote unit 102. In certain embodiments, the method 1400 may be performed by a processor executing program code, for example, a microcontroller, a microprocessor, a CPU, a GPU, an auxiliary processing unit, a FPGA, or the like.

In various embodiments, the method 1400 includes determining 1402, at a receiving device, a NC configuration for transmission of a scheduled network-coded ADU. In some embodiments, the method 1400 includes receiving 1404 the scheduled network-coded ADU in at least one TB. In certain embodiments, the method 1400 includes determining 1406, for each TB of the at least one TB, a CB threshold based at least on the NC configuration. In various embodiments, the method 1400 includes configuring 1408, for each TB of the at least one TB, a NC-aware HARQ process as a HARQ process with the CB threshold. In some embodiments, the method 1400 includes using 1410 the CB threshold to determine a NC-aware HARQ feedback report. In certain embodiments, the method 1400 includes feeding 1412 back the NC-aware HARQ feedback report to a transmitting device.

In certain embodiments, the NC configuration comprises: a type of NC codebook; a size of an NC packet; a size of an NC symbol; a number of systematic network-coded information carrying packets; a number of systematic network-coded information carrying symbols; a number of network-coded repair packets; a number of network-coded repair symbols; a total number of network-coded packets; a total number of network-coded symbols; a maximum size of a network-coded transmission; a redundancy level of the NC; or some combination thereof. In some embodiments, the NC configuration is signaled by a transmitter by: a semi-static radio resource control (RRC) signaling indication; a dynamic signaling indication of a downlink control information (DCI) scheduling at least one physical downlink shared channel (PDSCH) data traffic instance; a dynamic signaling indication of a DCI scheduling of at least one group of PDSCH data traffic instances; or some combination thereof. In various embodiments, the CB threshold encodes: a necessary minimum number of correctly received CB threshold; a tolerated maximum number of CB errors threshold; or a combination thereof.

In one embodiment, a correctness of a CB is determined based on a cyclic redundancy check (CRC) comparison with a correctly received CB validating the CRC and with an erroneously received CB not validating the CRC. In certain embodiments, any medium access control (MAC) protocol data unit (PDU) partly or fully contained within an erroneous CB of the TB of the at least one TB is discarded by higher layers from further processing. In some embodiments, determining the CB threshold comprises the receiver processing: a total number of network-coded information carrying packets; a total number of network-coded information carrying symbols; a number of source data packets to undergo NC; a number of source symbols to undergo NC; a number of network-coded systematic information carrying packets; an NC redundancy level; an available RRC and modulation and coding scheme (MCS) configuration information; or some combination thereof.

In various embodiments, determining the CB threshold comprises processing: a determination of an average number of network-coded packets per CB of a TB of the at least one transport block; a determination of a tolerated maximum number of only consecutive CB errors, nCB_{err,max}^{consecutive}, given the NC configuration, wherein the consecutive CB errors represent two or more sequential erroneous CBs; a determination of a tolerated maximum number of only non-consecutive CB errors, nCB_{err,max}^{nonconsecutive}, given the NC configuration, wherein a non-consecutive erroneous CB is any CB that contains at least one correct CB received between itself and any adjacent erroneous CB; a determination of a tolerated maximum number of CB errors threshold as a tuple of two, (nCB_{err,max}^{nonconsecutive}, nCB_{err,max}^{consecutive}), formed of a tolerated maximum number of CB errors scalar threshold considering all erroneous CBs to be non-consecutive, and of the tolerated maximum number of CB errors scalar threshold considering all erroneous CBs to be consecutive; a compression of the tolerated maximum number of CB errors threshold as the tuple of two to a singular scalar of a tolerated maximum number of CB errors threshold as nCBₑᵣᵣ^{tolerated}=min(nCB_{err,max}^{nonconsecutive}, nCB_{err,max}^{consecutive}); or some combination thereof.

In one embodiment, determining the CB threshold comprises processing: a determination of an average number of network-coded packets per CB of a TB of the at least one transport block of nCB CBs; a determination of a necessary minimum number of correctly received CBs scalar threshold, nCB−nCB_{err,max}^{consecutive}, given the NC configuration for only consecutive CB errors, wherein the consecutive CB errors represent two or more sequential erroneous CBs; a determination of a necessary minimum number of correctly received CBs scalar threshold, nCB−nCB_{err,max}^{nonconsecutive}, given the NC configuration for only non-consecutive CB errors, wherein a non-consecutive erroneous CB is any CB that contains at least one correct CB received between itself and any adjacent erroneous CB; a determination of a necessary minimum number of correctly received CBs threshold as a tuple of two, (nCB−nCB_{err,max}^{consecutive}, nCB−nCB_{err,max}^{nonconsecutive}), formed of the necessary minimum number of correctly received CBs scalar threshold considering all erroneous CBs to be consecutive, and of the necessary minimum number of correctly received CBs scalar threshold considering all erroneous CBs to be non-consecutive; a compression of the necessary minimum number of correctly received CBs threshold as the tuple of two to a singular scalar of a necessary minimum number of correctly received CBs threshold as nCB_{correct}^{necessary}=max (nCB−nCB_{err,max}^{consecutive}, nCB−nCB_{err,max}^{nonconsecutive}); or some combination thereof.

In certain embodiments, determining the CB threshold is performed by a transmitter and signaled to the receiver by: an RRC bit field indication made by semi-static signaling; a bit field indication made by dynamic signaling via a DCI scheduling at least one PDSCH transmission; a bit field indication made by dynamic signaling via a DCI scheduling at least one group of PDSCH transmissions; or some combination thereof. In some embodiments, the bit field indication comprises: a necessary minimum number of correctly received CBs threshold tuple (nCB−nCB_{err,max}^{consecutive}, nCB−nCB_{err,max}^{nonconsecutive}); a tolerated maximum number of CB errors threshold tuple (nCB_{err,max}^{nonconsecutive}, nCB_{err,max}^{consecutive}); a minimum number of correctly received CBs threshold scalar as nCB_{correct}^{necessary}; or a tolerated maximum number of CB errors threshold scalar as nCBₑᵣᵣ^{tolerated}.

In various embodiments, an encoding and bit length of the bit field indication is determined by: a dynamic encoding as either ┌log₂(a)+log₂(b)┐ bits for a tuple threshold (a, b), or as ┌log₂(a)┐ bits for a scalar threshold of numeric value a; or a semi-static fixed encoding of an indexed representation signaled by upper layers describing a plurality of possible threshold values, wherein the indexed representation maps to an associated threshold value. In one embodiment, the NC-aware HARQ process reports an acknowledgment (ACK) as HARQ feedback for a TB of the at least one TB in response to: a number of correctly received CBs being greater than or equal to the CB threshold as a necessary minimum number of correctly received CBs; a number of erroneously received CBs being less than or equal to the CB threshold as a tolerated maximum number of CB errors; or a combination thereof.

In certain embodiments, the NC-aware HARQ process reports non-acknowledgement (NACK) as HARQ feedback for a TB of the at least one TB in response to: a number of correctly received CBs being less than the CB threshold as a necessary minimum number of correctly received CBs; a number of erroneously received CBs being greater than the CB threshold as a tolerated maximum number of CB errors; or a combination thereof. In some embodiments, the method 1400 further comprises multiplexing the NC-aware HARQ feedback report with at least one HARQ feedback instance as: a semi-static type-1 HARQ codebook; or a dynamic type-2 HARQ codebook.

In various embodiments, the method 1400 further comprises dynamically enabling the NC-aware HARQ feedback report, disabling the NC-aware HARQ feedback report, or a combination thereof by: a semi-static RRC signaling; a dynamic indication by a DCI scheduling at least one PDSCH transmission; a dynamic indication by a DCI scheduling at least one group of PDSCH transmissions; or some combination thereof. In one embodiment, the method 1400 further comprises configuring code block group (CBG)-based retransmissions, wherein the NC-aware HARQ feedback report is multiplexed as a CBG-based HARQ codebook.

In certain embodiments, ACK is signaled for all CBGs of a TB of the at least one TB if the CB threshold is met as: a total number of correctly received CBs of the TB is greater than or equal to the CB threshold as a necessary minimum number of correctly received CBs; a total number of erroneously received CBs of the TB is less than or equal to the CB threshold as a tolerated maximum number of CB errors; or a combination thereof. In some embodiments, NACK is signaled for at least one CBG of a TB of the at least one TB if the CB threshold is not met as: a total number of correctly received CBs of the TB is less than the CB threshold as a necessary minimum number of correctly received CBs; a total number of erroneously received CBs of the TB is greater than the CB threshold as a tolerated maximum number of CB errors; or a combination thereof. In various embodiments, the NC-aware HARQ process determines the NACK for the at least one CBG by: ranking CBGs in descending order of their number of CB errors; determining a NACK for one or more top ranked CBGs whose number of erroneous CBs correctable by retransmissions would lower the number of erroneous CB to meet the CB threshold; determining an ACK for the rest of CBGs; or some combination thereof.

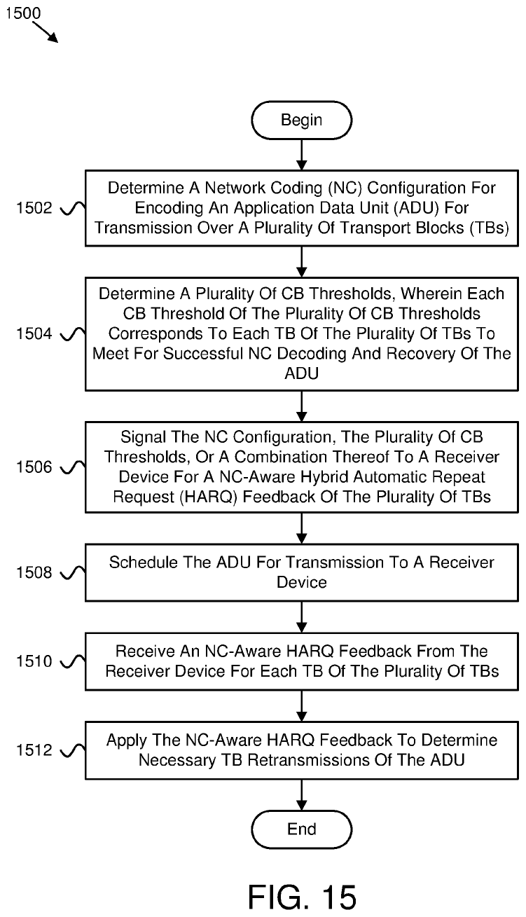

FIG. 15 is a flow chart diagram illustrating another embodiment of a method 1500 for configuring based on NC. In some embodiments, the method 1500 is performed by an apparatus, such as the network unit 104. In certain embodiments, the method 1500 may be performed by a processor executing program code, for example, a microcontroller, a microprocessor, a CPU, a GPU, an auxiliary processing unit, a FPGA, or the like.

In various embodiments, the method 1500 includes determining 1502, at a network device, a NC configuration for encoding an ADU for transmission over a plurality of transport blocks (TBs). In some embodiments, the method 1500 includes determining 1504 a plurality of CB thresholds, wherein each CB threshold of the plurality of CB thresholds corresponds to each TB of the plurality of TBs to meet for successful NC decoding and recovery of the ADU. In certain embodiments, the method 1500 includes signaling 1506 the NC configuration, the plurality of CB thresholds, or a combination thereof to a receiver device for a NC-aware HARQ feedback of the plurality of TBs. In various embodiments, the method 1500 includes scheduling 1508 the ADU for transmission to a receiver device. In some embodiments, the method 1500 includes receiving 1510 an NC-aware HARQ feedback from the receiver device for each TB of the plurality of TBs. In certain embodiments, the method 1500 includes applying 1512 the NC-aware HARQ feedback to determine necessary TB retransmissions of the ADU.

In certain embodiments, the NC configuration comprises: a type of NC codebook; a size of an NC packet; a size of an NC symbol; a number of systematic network-coded information carrying packets; a number of systematic network-coded information carrying symbols; a number of network-coded repair packets; a number of network-coded repair symbols; a total number of network-coded packets; a total number of network-coded symbols; a maximum size of a network-coded transmission; a redundancy level of the NC; or some combination thereof. In some embodiments, the NC configuration is signaled by a transmitter by: a semi-static radio resource control (RRC) signaling indication; a dynamic signaling indication of a downlink control information (DCI) scheduling at least one physical downlink shared channel (PDSCH) data traffic instance; a dynamic signaling indication of a DCI scheduling of at least one group of PDSCH data traffic instances; or some combination thereof.

In various embodiments, each CB threshold of the plurality of CB thresholds encodes: a necessary minimum number of correctly received CB threshold; a tolerated maximum number of CB errors threshold; or a combination thereof. In one embodiment, determining the plurality of CB thresholds comprises processing: a total number of network-coded information carrying packets; a total number of network-coded information carrying symbols; a number of source data packets to undergo NC; a number of source symbols to undergo NC; a number of network-coded systematic information carrying packets; an NC redundancy level; an available RRC and modulation and coding scheme (MCS) configuration information; or some combination thereof.

In certain embodiments, determining each CB threshold of the plurality of CB thresholds comprises processing: a determination of an average number of network-coded packets per CB of a TB; a determination of a tolerated maximum number of only consecutive CB errors, nCB_{err,max}^{consecutive}, given the NC configuration, wherein the consecutive CB errors represent two or more sequential erroneous CBs; a determination of a tolerated maximum number of only non-consecutive CB errors, nCB_{err,max}^{nonconsecutive}, given the NC configuration, wherein a non-consecutive erroneous CB is any CB that contains at least one correct CB received between itself and any adjacent erroneous CB; a determination of a tolerated maximum number of CB errors threshold as a tuple of two, (nCB_{err,max}^{nonconsecutive}, nCB_{err,max}^{consecutive}), formed of a tolerated maximum number of CB errors scalar threshold considering all erroneous CBs to be non-consecutive, and of the tolerated maximum number of CB errors scalar threshold considering all erroneous CBs to be consecutive; a compression of the tolerated maximum number of CB errors threshold as the tuple of two to a singular scalar of a tolerated maximum number of CB errors threshold as nCBₑᵣᵣ^{tolerated}=min(nCB_{err,max}^{nonconsecutive}, nCB_{err,max}^{consecutive}); or some combination thereof.

In some embodiments, determining each CB threshold of the plurality of CB thresholds comprises processing: a determination of an average number of network-coded packets per CB of a TB of nCB CBs; a determination of a necessary minimum number of correctly received CBs scalar threshold, nCB−nCB_{err,max}^{consecutive}, given the NC configuration for only consecutive CB errors, wherein the consecutive CB errors represent two or more sequential erroneous CBs; a determination of a necessary minimum number of correctly received CBs scalar threshold, nCB−nCB_{err,max}^{nonconsecutive}, given the NC configuration for only non-consecutive CB errors, wherein a non-consecutive erroneous CB is any CB that contains at least one correct CB received between itself and any adjacent erroneous CB; a determination of a necessary minimum number of correctly received CBs threshold as a tuple of two, (nCB−nCB_{err,max}^{consecutive}, nCB−nCB_{err,max}^{nonconsecutive}), formed of the necessary minimum number of correctly received CBs scalar threshold considering all erroneous CBs to be consecutive, and of the necessary minimum number of correctly received CBs scalar threshold considering all erroneous CBs to be non-consecutive; a compression of the necessary minimum number of correctly received CBs threshold as the tuple of two to a singular scalar of a necessary minimum number of correctly received CBs threshold as nCB_{correct}^{necessary}=max(nCB−nCB_{err,max}^{consecutive}, nCB−nCB_{err,max}^{nonconsecutive}); or some combination thereof.

In various embodiments, signaling the plurality of CB thresholds is performed by a transmitter and signaled to the receiver device by: an RRC bit field indication made by semi-static signaling; a bit field indication made by dynamic signaling via a DCI scheduling at least one PDSCH transmission; a bit field indication made by dynamic signaling via a DCI scheduling at least one group of PDSCH transmissions; or some combination thereof. In one embodiment, the bit field indication for each CB threshold of the plurality of CB thresholds comprises: a necessary minimum number of correctly received CBs threshold tuple (nCB−nCB_{err,max}^{consecutive}, nCB−nCB_{err,max}^{nonconsecutive}); a tolerated maximum number of CB errors threshold tuple (nCB_{err,max}^{nonconsecutive}, nCB_{err,max}^{consecutive}); a minimum number of correctly received CBs threshold scalar as nCB_{correct}^{necessary}; or a tolerated maximum number of CB errors threshold scalar as nCBₑᵣᵣ^{tolerated}. In certain embodiments, an encoding and bit length of the bit field indication is determined by: a dynamic encoding as either ┌log₂(a)+log₂(b)┐ bits for a tuple threshold (a, b), or as ┌log₂(a)┐ bits for a scalar threshold of numeric value a; or a semi-static fixed encoding of an indexed representation signaled by upper layers describing a plurality of possible threshold values, wherein the indexed representation maps to an associated threshold value.

In one embodiment, an apparatus comprises a receiving device. The apparatus further comprises: a processor that determines a NC configuration for transmission of a scheduled network-coded ADU; a receiver that receives the scheduled network-coded ADU in at least one TB, wherein the processor: determines, for each TB of the at least one TB, a CB threshold based at least on the NC configuration; configures, for each TB of the at least one TB, a NC-aware HARQ process as a HARQ process with the CB threshold; and uses the CB threshold to determine a NC-aware HARQ feedback report; and a transmitter that feeds back the NC-aware HARQ feedback report to a transmitting device.

In certain embodiments, the NC configuration comprises: a type of NC codebook; a size of an NC packet; a size of an NC symbol; a number of systematic network-coded information carrying packets; a number of systematic network-coded information carrying symbols; a number of network-coded repair packets; a number of network-coded repair symbols; a total number of network-coded packets; a total number of network-coded symbols; a maximum size of a network-coded transmission; a redundancy level of the NC; or some combination thereof.

In some embodiments, the NC configuration is signaled by a transmitter by: a semi-static radio resource control (RRC) signaling indication; a dynamic signaling indication of a downlink control information (DCI) scheduling at least one physical downlink shared channel (PDSCH) data traffic instance; a dynamic signaling indication of a DCI scheduling of at least one group of PDSCH data traffic instances; or some combination thereof.

In various embodiments, the CB threshold encodes: a necessary minimum number of correctly received CB threshold; a tolerated maximum number of CB errors threshold; or a combination thereof.

In one embodiment, a correctness of a CB is determined based on a cyclic redundancy check (CRC) comparison with a correctly received CB validating the CRC and with an erroneously received CB not validating the CRC.

In certain embodiments, any medium access control (MAC) protocol data unit (PDU) partly or fully contained within an erroneous CB of the TB of the at least one TB is discarded by higher layers from further processing.

In some embodiments, the processor determining the CB threshold comprises the receiver processing: a total number of network-coded information carrying packets; a total number of network-coded information carrying symbols; a number of source data packets to undergo NC; a number of source symbols to undergo NC; a number of network-coded systematic information carrying packets; an NC redundancy level; an available RRC and modulation and coding scheme (MCS) configuration information; or some combination thereof.

In various embodiments, the processor determining the CB threshold comprises the processor processing: a determination of an average number of network-coded packets per CB of a TB of the at least one transport block; a determination of a tolerated maximum number of only consecutive CB errors, nCB_{err,max}^{consecutive}, given the NC configuration, wherein the consecutive CB errors represent two or more sequential erroneous CBs; a determination of a tolerated maximum number of only non-consecutive CB errors, nCB_{err,max}^{nonconsecutive}, given the NC configuration, wherein a non-consecutive erroneous CB is any CB that contains at least one correct CB received between itself and any adjacent erroneous CB; a determination of a tolerated maximum number of CB errors threshold as a tuple of two, (nCB_{err,max}^{nonconsecutive}, nCB_{err,max}^{consecutive}), formed of a tolerated maximum number of CB errors scalar threshold considering all erroneous CBs to be non-consecutive, and of the tolerated maximum number of CB errors scalar threshold considering all erroneous CBs to be consecutive; a compression of the tolerated maximum number of CB errors threshold as the tuple of two to a singular scalar of a tolerated maximum number of CB errors threshold as nCBₑᵣᵣ^{tolerated}=min(nCB_{err,max}^{nonconsecutive}, nCB_{err,max}^{consecutive}); or some combination thereof.

In one embodiment, the processor determining the CB threshold comprises the processor processing: a determination of an average number of network-coded packets per CB of a TB of the at least one transport block of nCB CBs; a determination of a necessary minimum number of correctly received CBs scalar threshold, nCB−nCB_{err,max}^{consecutive}, given the NC configuration for only consecutive CB errors, wherein the consecutive CB errors represent two or more sequential erroneous CBs; a determination of a necessary minimum number of correctly received CBs scalar threshold, nCB−nCB_{err,max}^{nonconsecutive}, given the NC configuration for only non-consecutive CB errors, wherein a non-consecutive erroneous CB is any CB that contains at least one correct CB received between itself and any adjacent erroneous CB; a determination of a necessary minimum number of correctly received CBs threshold as a tuple of two, (nCB−nCB_{err,max}^{consecutive}, nCB−nCB_{err,max}^{nonconsecutive}), formed of the necessary minimum number of correctly received CBs scalar threshold considering all erroneous CBs to be consecutive, and of the necessary minimum number of correctly received CBs scalar threshold considering all erroneous CBs to be non-consecutive; a compression of the necessary minimum number of correctly received CBs threshold as the tuple of two to a singular scalar of a necessary minimum number of correctly received CBs threshold as nCB_{correct}^{necessary}=max(nCB−nCB_{err,max}^{consecutive}, nCB−nCB_{err,max}^{nonconsecutive}); or some combination thereof.

In certain embodiments, the processor determining the CB threshold is performed by a transmitter and signaled to the receiver by: an RRC bit field indication made by semi-static signaling; a bit field indication made by dynamic signaling via a DCI scheduling at least one PDSCH transmission; a bit field indication made by dynamic signaling via a DCI scheduling at least one group of PDSCH transmissions; or some combination thereof.

In some embodiments, the bit field indication comprises: a necessary minimum number of correctly received CBs threshold tuple (nCB−nCB_{err,max}^{consecutive}, nCB−nCB_{err,max}^{nonconsecutive}); a tolerated maximum number of CB errors threshold tuple (nCB_{err,max}^{nonconsecutive}, nCB_{err,max}^{consecutive}); a minimum number of correctly received CBs threshold scalar as nCB_{correct}^{necessary}; or a tolerated maximum number of CB errors threshold scalar as nCBₑᵣᵣ^{tolerated}.

In various embodiments, an encoding and bit length of the bit field indication is determined by: a dynamic encoding as either ┌log₂(a)+log₂(b)┐ bits for a tuple threshold (a, b), or as ┌log₂(a)┐ bits for a scalar threshold of numeric value a; or a semi-static fixed encoding of an indexed representation signaled by upper layers describing a plurality of possible threshold values, wherein the indexed representation maps to an associated threshold value.

In one embodiment, the NC-aware HARQ process reports an acknowledgment (ACK) as HARQ feedback for a TB of the at least one TB in response to: a number of correctly received CBs being greater than or equal to the CB threshold as a necessary minimum number of correctly received CBs; a number of erroneously received CBs being less than or equal to the CB threshold as a tolerated maximum number of CB errors; or a combination thereof.

In certain embodiments, the NC-aware HARQ process reports non-acknowledgement (NACK) as HARQ feedback for a TB of the at least one TB in response to: a number of correctly received CBs being less than the CB threshold as a necessary minimum number of correctly received CBs; a number of erroneously received CBs being greater than the CB threshold as a tolerated maximum number of CB errors; or a combination thereof.

In some embodiments, the processor multiplexes the NC-aware HARQ feedback report with at least one HARQ feedback instance as: a semi-static type-1 HARQ codebook; or a dynamic type-2 HARQ codebook.

In various embodiments, the processor dynamically enables the NC-aware HARQ feedback report, disabling the NC-aware HARQ feedback report, or a combination thereof by: a semi-static RRC signaling; a dynamic indication by a DCI scheduling at least one PDSCH transmission; a dynamic indication by a DCI scheduling at least one group of PDSCH transmissions; or some combination thereof.

In one embodiment, the processor configures code block group (CBG)-based retransmissions, and the NC-aware HARQ feedback report is multiplexed as a CBG-based HARQ codebook.

In certain embodiments, ACK is signaled for all CBGs of a TB of the at least one TB if the CB threshold is met as: a total number of correctly received CBs of the TB is greater than or equal to the CB threshold as a necessary minimum number of correctly received CBs; a total number of erroneously received CBs of the TB is less than or equal to the CB threshold as a tolerated maximum number of CB errors; or a combination thereof.

In some embodiments, NACK is signaled for at least one CBG of a TB of the at least one TB if the CB threshold is not met as: a total number of correctly received CBs of the TB is less than the CB threshold as a necessary minimum number of correctly received CBs; a total number of erroneously received CBs of the TB is greater than the CB threshold as a tolerated maximum number of CB errors; or a combination thereof.

In various embodiments, the NC-aware HARQ process determines the NACK for the at least one CBG by: ranking CBGs in descending order of their number of CB errors; determining a NACK for one or more top ranked CBGs whose number of erroneous CBs correctable by retransmissions would lower the number of erroneous CB to meet the CB threshold; determining an ACK for the rest of CBGs; or some combination thereof.

In one embodiment, a method of a receiving device comprises: determining a NC configuration for transmission of a scheduled network-coded ADU; receiving the scheduled network-coded ADU in at least one TB; determining, for each TB of the at least one TB, a CB threshold based at least on the NC configuration; configuring, for each TB of the at least one TB, a NC-aware HARQ process as a HARQ process with the CB threshold; using the CB threshold to determine a NC-aware HARQ feedback report; and feeding back the NC-aware HARQ feedback report to a transmitting device.

In certain embodiments, the NC configuration comprises: a type of NC codebook; a size of an NC packet; a size of an NC symbol; a number of systematic network-coded information carrying packets; a number of systematic network-coded information carrying symbols; a number of network-coded repair packets; a number of network-coded repair symbols; a total number of network-coded packets; a total number of network-coded symbols; a maximum size of a network-coded transmission; a redundancy level of the NC; or some combination thereof.

In some embodiments, the NC configuration is signaled by a transmitter by: a semi-static radio resource control (RRC) signaling indication; a dynamic signaling indication of a downlink control information (DCI) scheduling at least one physical downlink shared channel (PDSCH) data traffic instance; a dynamic signaling indication of a DCI scheduling of at least one group of PDSCH data traffic instances; or some combination thereof.

In various embodiments, the CB threshold encodes: a necessary minimum number of correctly received CB threshold; a tolerated maximum number of CB errors threshold; or a combination thereof.

In one embodiment, a correctness of a CB is determined based on a cyclic redundancy check (CRC) comparison with a correctly received CB validating the CRC and with an erroneously received CB not validating the CRC.

In certain embodiments, any medium access control (MAC) protocol data unit (PDU) partly or fully contained within an erroneous CB of the TB of the at least one TB is discarded by higher layers from further processing.

In some embodiments, determining the CB threshold comprises the receiver processing: a total number of network-coded information carrying packets; a total number of network-coded information carrying symbols; a number of source data packets to undergo NC; a number of source symbols to undergo NC; a number of network-coded systematic information carrying packets; an NC redundancy level; an available RRC and modulation and coding scheme (MCS) configuration information; or some combination thereof.

In various embodiments, determining the CB threshold comprises processing: a determination of an average number of network-coded packets per CB of a TB of the at least one transport block; a determination of a tolerated maximum number of only consecutive CB errors, nCB_{err,max}^{consecutive}, given the NC configuration, wherein the consecutive CB errors represent two or more sequential erroneous CBs; a determination of a tolerated maximum number of only non-consecutive CB errors, nCB_{err,max}^{nonconsecutive}, given the NC configuration, wherein a non-consecutive erroneous CB is any CB that contains at least one correct CB received between itself and any adjacent erroneous CB; a determination of a tolerated maximum number of CB errors threshold as a tuple of two, (nCB_{err,max}^{nonconsecutive}, nCB_{err,max}^{consecutive}), formed of a tolerated maximum number of CB errors scalar threshold considering all erroneous CBs to be non-consecutive, and of the tolerated maximum number of CB errors scalar threshold considering all erroneous CBs to be consecutive; a compression of the tolerated maximum number of CB errors threshold as the tuple of two to a singular scalar of a tolerated maximum number of CB errors threshold as nCBₑᵣᵣ^{tolerated}=min(nCB_{err,max}^{nonconsecutive}, nCB_{err,max}^{consecutive}); or some combination thereof.

In one embodiment, determining the CB threshold comprises processing: a determination of an average number of network-coded packets per CB of a TB of the at least one transport block of nCB CBs; a determination of a necessary minimum number of correctly received CBs scalar threshold, nCB−nCB_{err,max}^{consecutive}, given the NC configuration for only consecutive CB errors, wherein the consecutive CB errors represent two or more sequential erroneous CBs; a determination of a necessary minimum number of correctly received CBs scalar threshold, nCB−nCB_{err,max}^{nonconsecutive}, given the NC configuration for only non-consecutive CB errors, wherein a non-consecutive erroneous CB is any CB that contains at least one correct CB received between itself and any adjacent erroneous CB; a determination of a necessary minimum number of correctly received CBs threshold as a tuple of two, (nCB−nCB_{err,max}^{consecutive}, nCB−nCB_{err,max}^{nonconsecutive}), formed of the necessary minimum number of correctly received CBs scalar threshold considering all erroneous CBs to be consecutive, and of the necessary minimum number of correctly received CBs scalar threshold considering all erroneous CBs to be non-consecutive; a compression of the necessary minimum number of correctly received CBs threshold as the tuple of two to a singular scalar of a necessary minimum number of correctly received CBs threshold as nCB_{correct}^{necessary}=max(nCB−nCB_{err,max}^{consecutive}, nCB−nCB_{err,max}^{nonconsecutive}); or some combination thereof.

In certain embodiments, determining the CB threshold is performed by a transmitter and signaled to the receiver by: an RRC bit field indication made by semi-static signaling; a bit field indication made by dynamic signaling via a DCI scheduling at least one PDSCH transmission; a bit field indication made by dynamic signaling via a DCI scheduling at least one group of PDSCH transmissions; or some combination thereof.

In some embodiments, the bit field indication comprises: a necessary minimum number of correctly received CBs threshold tuple (nCB−nCB_{err,max}^{consecutive}, nCB−nCB_{err,max}^{nonconsecutive}); a tolerated maximum number of CB errors threshold tuple nCB_{err,max}^{nonconsecutive}, nCB_{err,max}^{consecutive}); a minimum number of correctly received CBs threshold scalar as nCB_{correct}^{necessary}; or a tolerated maximum number of CB errors threshold scalar as nCBₑᵣᵣ^{tolerated}.

In various embodiments, an encoding and bit length of the bit field indication is determined by: a dynamic encoding as either ┌log₂(a)+log₂(b)┐ bits for a tuple threshold (a, b), or as ┌log₂(a)┐ bits for a scalar threshold of numeric value a; or a semi-static fixed encoding of an indexed representation signaled by upper layers describing a plurality of possible threshold values, wherein the indexed representation maps to an associated threshold value.

In one embodiment, the NC-aware HARQ process reports an acknowledgment (ACK) as HARQ feedback for a TB of the at least one TB in response to: a number of correctly received CBs being greater than or equal to the CB threshold as a necessary minimum number of correctly received CBs; a number of erroneously received CBs being less than or equal to the CB threshold as a tolerated maximum number of CB errors; or a combination thereof.

In certain embodiments, the NC-aware HARQ process reports non-acknowledgement (NACK) as HARQ feedback for a TB of the at least one TB in response to: a number of correctly received CBs being less than the CB threshold as a necessary minimum number of correctly received CBs; a number of erroneously received CBs being greater than the CB threshold as a tolerated maximum number of CB errors; or a combination thereof.

In some embodiments, the method further comprises multiplexing the NC-aware HARQ feedback report with at least one HARQ feedback instance as: a semi-static type-1 HARQ codebook; or a dynamic type-2 HARQ codebook.

In various embodiments, the method further comprises dynamically enabling the NC-aware HARQ feedback report, disabling the NC-aware HARQ feedback report, or a combination thereof by: a semi-static RRC signaling; a dynamic indication by a DCI scheduling at least one PDSCH transmission; a dynamic indication by a DCI scheduling at least one group of PDSCH transmissions; or some combination thereof.

In one embodiment, the method further comprises configuring code block group (CBG)-based retransmissions, wherein the NC-aware HARQ feedback report is multiplexed as a CBG-based HARQ codebook.

In certain embodiments, ACK is signaled for all CBGs of a TB of the at least one TB if the CB threshold is met as: a total number of correctly received CBs of the TB is greater than or equal to the CB threshold as a necessary minimum number of correctly received CBs; a total number of erroneously received CBs of the TB is less than or equal to the CB threshold as a tolerated maximum number of CB errors; or a combination thereof.

In some embodiments, NACK is signaled for at least one CBG of a TB of the at least one TB if the CB threshold is not met as: a total number of correctly received CBs of the TB is less than the CB threshold as a necessary minimum number of correctly received CBs; a total number of erroneously received CBs of the TB is greater than the CB threshold as a tolerated maximum number of CB errors; or a combination thereof.

In various embodiments, the NC-aware HARQ process determines the NACK for the at least one CBG by: ranking CBGs in descending order of their number of CB errors; determining a NACK for one or more top ranked CBGs whose number of erroneous CBs correctable by retransmissions would lower the number of erroneous CB to meet the CB threshold; determining an ACK for the rest of CBGs; or some combination thereof.

In one embodiment, an apparatus comprises a network device. The apparatus further comprises: a processor that: determines a NC configuration for encoding an ADU for transmission over a plurality of transport blocks (TBs); determines a plurality of CB thresholds, wherein each CB threshold of the plurality of CB thresholds corresponds to each TB of the plurality of TBs to meet for successful NC decoding and recovery of the ADU; signals the NC configuration, the plurality of CB thresholds, or a combination thereof to a receiver device for a NC-aware HARQ feedback of the plurality of TBs; and schedules the ADU for transmission to a receiver device; and a receiver that receives an NC-aware HARQ feedback from the receiver device for each TB of the plurality of TBs, wherein the processor applies the NC-aware HARQ feedback to determine necessary TB retransmissions of the ADU.

In certain embodiments, the NC configuration comprises: a type of NC codebook; a size of an NC packet; a size of an NC symbol; a number of systematic network-coded information carrying packets; a number of systematic network-coded information carrying symbols; a number of network-coded repair packets; a number of network-coded repair symbols; a total number of network-coded packets; a total number of network-coded symbols; a maximum size of a network-coded transmission; a redundancy level of the NC; or some combination thereof.

In some embodiments, the NC configuration is signaled by a transmitter by: a semi-static radio resource control (RRC) signaling indication; a dynamic signaling indication of a downlink control information (DCI) scheduling at least one physical downlink shared channel (PDSCH) data traffic instance; a dynamic signaling indication of a DCI scheduling of at least one group of PDSCH data traffic instances; or some combination thereof.

In various embodiments, each CB threshold of the plurality of CB thresholds encodes: a necessary minimum number of correctly received CB threshold; a tolerated maximum number of CB errors threshold; or a combination thereof.

In one embodiment, the processor determining the plurality of CB thresholds comprises processing: a total number of network-coded information carrying packets; a total number of network-coded information carrying symbols; a number of source data packets to undergo NC; a number of source symbols to undergo NC; a number of network-coded systematic information carrying packets; an NC redundancy level; an available RRC and modulation and coding scheme (MCS) configuration information; or some combination thereof.

In certain embodiments, the processor determining each CB threshold of the plurality of CB thresholds comprises the processor processing: a determination of an average number of network-coded packets per CB of a TB; a determination of a tolerated maximum number of only consecutive CB errors, nCB_{err,max}^{consecutive}, given the NC configuration, wherein the consecutive CB errors represent two or more sequential erroneous CBs; a determination of a tolerated maximum number of only non-consecutive CB errors, nCB_{err,max}^{nonconsecutive}, given the NC configuration, wherein a non-consecutive erroneous CB is any CB that contains at least one correct CB received between itself and any adjacent erroneous CB; a determination of a tolerated maximum number of CB errors threshold as a tuple of two, (nCB_{err,max}^{nonconsecutive}, nCB_{err,max}^{consecutive}), formed of a tolerated maximum number of CB errors scalar threshold considering all erroneous CBs to be non-consecutive, and of the tolerated maximum number of CB errors scalar threshold considering all erroneous CBs to be consecutive; a compression of the tolerated maximum number of CB errors threshold as the tuple of two to a singular scalar of a tolerated maximum number of CB errors threshold as nCBₑᵣᵣ^{tolerated}=min(nCB_{err,max}^{nonconsecutive}, nCB_{err,max}^{consecutive}); or some combination thereof.

In some embodiments, the processor determining each CB threshold of the plurality of CB thresholds comprises the processor processing: a determination of an average number of network-coded packets per CB of a TB of nCB CBs; a determination of a necessary minimum number of correctly received CBs scalar threshold, nCB−nCB_{err,max}^{consecutive}, given the NC configuration for only consecutive CB errors, wherein the consecutive CB errors represent two or more sequential erroneous CBs; a determination of a necessary minimum number of correctly received CBs scalar threshold, nCB−nCB_{err,max}^{nonconsecutive}, given the NC configuration for only non-consecutive CB errors, wherein a non-consecutive erroneous CB is any CB that contains at least one correct CB received between itself and any adjacent erroneous CB; a determination of a necessary minimum number of correctly received CBs threshold as a tuple of two, (nCB−nCB_{err,max}^{consecutive}, nCB−nCB_{err,max}^{nonconsecutive}), formed of the necessary minimum number of correctly received CBs scalar threshold considering all erroneous CBs to be consecutive, and of the necessary minimum number of correctly received CBs scalar threshold considering all erroneous CBs to be non-consecutive; a compression of the necessary minimum number of correctly received CBs threshold as the tuple of two to a singular scalar of a necessary minimum number of correctly received CBs threshold as nCB_{correct}^{necessary}=max(nCB−nCB_{err,max}^{consecutive}, nCB−nCB_{err,max}^{nonconsecutive}); or some combination thereof.

In various embodiments, the processor signaling the plurality of CB thresholds is performed by a transmitter and signaled to the receiver device by: an RRC bit field indication made by semi-static signaling; a bit field indication made by dynamic signaling via a DCI scheduling at least one PDSCH transmission; a bit field indication made by dynamic signaling via a DCI scheduling at least one group of PDSCH transmissions; or some combination thereof.

In one embodiment, the bit field indication for each CB threshold of the plurality of CB thresholds comprises: a necessary minimum number of correctly received CBs threshold tuple (nCB−nCB_{err,max}^{consecutive}, nCB−nCB_{err,max}^{nonconsecutive}); a tolerated maximum number of CB errors threshold tuple (nCB_{err,max}^{nonconsecutive}, nCB_{err,max}^{consecutive}); a minimum number of correctly received CBs threshold scalar as nCB_{correct}^{necessary}; or a tolerated maximum number of CB errors threshold scalar as nCBₑᵣᵣ^{tolerated}.

In certain embodiments, an encoding and bit length of the bit field indication is determined by: a dynamic encoding as either ┌log₂(a)+log₂(b)┐ bits for a tuple threshold (a, b), or as ┌log₂(a)┐ bits for a scalar threshold of numeric value a; or a semi-static fixed encoding of an indexed representation signaled by upper layers describing a plurality of possible threshold values, wherein the indexed representation maps to an associated threshold value.

In one embodiment, a method of a network device comprises: determining a NC configuration for encoding an ADU for transmission over a plurality of transport blocks (TBs); determining a plurality of CB thresholds, wherein each CB threshold of the plurality of CB thresholds corresponds to each TB of the plurality of TBs to meet for successful NC decoding and recovery of the ADU; signaling the NC configuration, the plurality of CB thresholds, or a combination thereof to a receiver device for a NC-aware HARQ feedback of the plurality of TBs; scheduling the ADU for transmission to a receiver device; receiving an NC-aware HARQ feedback from the receiver device for each TB of the plurality of TBs; and applying the NC-aware HARQ feedback to determine necessary TB retransmissions of the ADU.

In certain embodiments, the NC configuration comprises: a type of NC codebook; a size of an NC packet; a size of an NC symbol; a number of systematic network-coded information carrying packets; a number of systematic network-coded information carrying symbols; a number of network-coded repair packets; a number of network-coded repair symbols; a total number of network-coded packets; a total number of network-coded symbols; a maximum size of a network-coded transmission; a redundancy level of the NC; or some combination thereof.

In some embodiments, the NC configuration is signaled by a transmitter by: a semi-static radio resource control (RRC) signaling indication; a dynamic signaling indication of a downlink control information (DCI) scheduling at least one physical downlink shared channel (PDSCH) data traffic instance; a dynamic signaling indication of a DCI scheduling of at least one group of PDSCH data traffic instances; or some combination thereof.

In various embodiments, each CB threshold of the plurality of CB thresholds encodes: a necessary minimum number of correctly received CB threshold; a tolerated maximum number of CB errors threshold; or a combination thereof.

In one embodiment, determining the plurality of CB thresholds comprises processing: a total number of network-coded information carrying packets; a total number of network-coded information carrying symbols; a number of source data packets to undergo NC; a number of source symbols to undergo NC; a number of network-coded systematic information carrying packets; an NC redundancy level; an available RRC and modulation and coding scheme (MCS) configuration information; or some combination thereof.

In certain embodiments, determining each CB threshold of the plurality of the CB thresholds comprises processing: a determination of an average number of network-coded packets per CB of a TB; a determination of a tolerated maximum number of only consecutive CB errors, nCB_{err,max}^{consecutive}, given the NC configuration, wherein the consecutive CB errors represent two or more sequential erroneous CBs; a determination of a tolerated maximum number of only non-consecutive CB errors, nCB_{err,max}^{nonconsecutive}, given the NC configuration, wherein a non-consecutive erroneous CB is any CB that contains at least one correct CB received between itself and any adjacent erroneous CB; a determination of a tolerated maximum number of CB errors threshold as a tuple of two, (nCB_{err,max}^{nonconsecutive}, nCB_{err,max}^{consecutive}), formed of a tolerated maximum number of CB errors scalar threshold considering all erroneous CBs to be non-consecutive, and of the tolerated maximum number of CB errors scalar threshold considering all erroneous CBs to be consecutive; a compression of the tolerated maximum number of CB errors threshold as the tuple of two to a singular scalar of a tolerated maximum number of CB errors threshold as nCBₑᵣᵣ^{tolerated}=min(nCB_{err,max}^{nonconsecutive}, nCB_{err,max}^{consecutive}); or some combination thereof.

In some embodiments, determining each CB threshold of the plurality of CB thresholds comprises processing: a determination of an average number of network-coded packets per CB of a TB of nCB CBs; a determination of a necessary minimum number of correctly received CBs scalar threshold, nCB−nCB_{err,max}^{consecutive}, given the NC configuration for only consecutive CB errors, wherein the consecutive CB errors represent two or more sequential erroneous CBs; a determination of a necessary minimum number of correctly received CBs scalar threshold, nCB−nCB_{err,max}^{nonconsecutive}, given the NC configuration for only non-consecutive CB errors, wherein a non-consecutive erroneous CB is any CB that contains at least one correct CB received between itself and any adjacent erroneous CB; a determination of a necessary minimum number of correctly received CBs threshold as a tuple of two, (nCB−nCB_{err,max}^{consecutive}, nCB−nCB_{err,max}^{nonconsecutive}), formed of the necessary minimum number of correctly received CBs scalar threshold considering all erroneous CBs to be consecutive, and of the necessary minimum number of correctly received CBs scalar threshold considering all erroneous CBs to be non-consecutive; a compression of the necessary minimum number of correctly received CBs threshold as the tuple of two to a singular scalar of a necessary minimum number of correctly received CBs threshold as nCB_{correct}^{necessary}=max(nCB−nCB_{err,max}^{consecutive}, nCB−nCB_{err,max}^{nonconsecutive}); or some combination thereof.

In various embodiments, signaling the plurality of CB thresholds is performed by a transmitter and signaled to the receiver device by: an RRC bit field indication made by semi-static signaling; a bit field indication made by dynamic signaling via a DCI scheduling at least one PDSCH transmission; a bit field indication made by dynamic signaling via a DCI scheduling at least one group of PDSCH transmissions; or some combination thereof.

In one embodiment, the bit field indication for each CB threshold of the plurality of CB thresholds comprises: a necessary minimum number of correctly received CBs threshold tuple (nCB−nCB_{err,max}^{consecutive}, nCB−nCB_{err,max}^{nonconsecutive}); a tolerated maximum number of CB errors threshold tuple (nCB_{err,max}^{nonconsecutive}, nCB_{err,max}^{consecutive}); a minimum number of correctly received CBs threshold scalar as nCB_{correct}^{necessary}; or a tolerated maximum number of CB errors threshold scalar as nCBₑᵣᵣ^{tolerated}.

In certain embodiments, an encoding and bit length of the bit field indication is determined by: a dynamic encoding as either ┌log₂(a)+log₂(b)┐ bits for a tuple threshold (a, b), or as ┌log₂(a)┐ bits for a scalar threshold of numeric value a; or a semi-static fixed encoding of an indexed representation signaled by upper layers describing a plurality of possible threshold values, wherein the indexed representation maps to an associated threshold value.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
determine a network coding (NC) configuration for transmission of a scheduled network-coded application data unit (ADU);
receive the scheduled network-coded ADU in at least one transport block (TB);
determine, for each TB of the at least one TB, a code block (CB) threshold based at least on the NC configuration;
configure, for each TB of the at least one TB, a NC-aware hybrid automatic repeat request (HARQ) process as a HARQ process with the CB threshold;
use the CB threshold to determine a NC-aware HARQ feedback report; and
feed back the NC-aware HARQ feedback report to a transmitting device.

2. The UE of claim 1, wherein the NC configuration comprises:
a type of NC codebook;
a size of an NC packet;
a size of an NC symbol;
a number of systematic network-coded information carrying packets;
a number of systematic network-coded information carrying symbols;
a number of network-coded repair packets;
a number of network-coded repair symbols;
a total number of network-coded packets;
a total number of network-coded symbols;
a maximum size of a network-coded transmission;
a redundancy level of the NC;
or a combination thereof.

3. The UE of claim 1, whereby the NC configuration is signaled by:
a semi-static radio resource control (RRC) signaling indication;
a dynamic signaling indication of a downlink control information (DCI) scheduling at least one physical downlink shared channel (PDSCH) data traffic instance;
a dynamic signaling indication of a DCI scheduling of at least one group of PDSCH data traffic instances;
or a combination thereof.

4. The UE of claim 1, wherein the CB threshold encodes:
a necessary minimum number of correctly received CB threshold;
a tolerated maximum number of CB errors threshold;
or a combination thereof.

5. The UE of claim 4, wherein a correctness of a CB is determined based on a cyclic redundancy check (CRC) comparison with a correctly received CB validating the CRC and with an erroneously received CB not validating the CRC.

6. The UE of claim 5, wherein any medium access control (MAC) protocol data unit (PDU) partly or fully contained within an erroneous CB of the TB of the at least one TB is discarded by higher layers from further processing.

7. The UE of claim 1, wherein the at least one processor is configured to cause the UE to process:
a total number of network-coded information carrying packets;
a total number of network-coded information carrying symbols;
a number of source data packets to undergo NC;
a number of source symbols to undergo NC;
a number of network-coded systematic information carrying packets;
an NC redundancy level;
an available RRC and modulation and coding scheme (MCS) configuration information;
or a combination thereof.

8. The UE of claim 1, wherein the at least one processor is configured to cause the UE to process:
a determination of an average number of network-coded packets per CB of a TB of the at least one transport block;
a determination of a tolerated maximum number of only consecutive CB errors, nCB_{err,max}^{consecutive}iven the NC configuration, wherein the consecutive CB errors represent two or more sequential erroneous CBs;
a determination of a tolerated maximum number of only non-consecutive CB errors, nCB_{err,max}^{nonconsecutive}iven the NC configuration, wherein a non-consecutive erroneous CB is any CB that contains at least one correct CB received between itself and any adjacent erroneous CB;
a determination of a tolerated maximum number of CB errors threshold as a tuple of two, (nCB_{err,max}^{nonconsecutive},nCB_{err,max}^{consecutive}),d of a tolerated maximum number of CB errors scalar threshold considering all erroneous CBs to be non-consecutive, and of the tolerated maximum number of CB errors scalar threshold considering all erroneous CBs to be consecutive;
a compression of the tolerated maximum number of CB errors threshold as the tuple of two to a singular scalar of a tolerated maximum number of CB errors threshold as nCBₑᵣᵣ^{tolerated}=min(nCB_{err,max}^{nonconsecutive}, nCB_{err,max}^{consecutive}) combination thereof.

9. The UE of claim 1, wherein the at least one processor is configured to cause the UE to process:
a determination of an average number of network-coded packets per CB of a TB of the at least one transport block of nCB CBs;
a determination of a necessary minimum number of correctly received CBs scalar threshold, nCB−nCB_{err,max}^{consecutive}iven the NC configuration for only consecutive CB errors, wherein the consecutive CB errors represent two or more sequential erroneous CBs;
a determination of a necessary minimum number of correctly received CBs scalar threshold, nCB−nCB_{err,max}^{nonconsecutive}iven the NC configuration for only non-consecutive CB errors, wherein a non-consecutive erroneous CB is any CB that contains at least one correct CB received between itself and any adjacent erroneous CB;
a determination of a necessary minimum number of correctly received CBs threshold as a tuple of two, (nCB−nCB_{err,max}^{consecutive}, nCB−nCB_{err,max}^{nonconsecutive}),d of the necessary minimum number of correctly received CBs scalar threshold considering all erroneous CBs to be consecutive, and of the necessary minimum number of correctly received CBs scalar threshold considering all erroneous CBs to be non-consecutive;
a compression of the necessary minimum number of correctly received CBs threshold as the tuple of two to a singular scalar of a necessary minimum number of correctly received CBs threshold as nCB_{correct}^{necessary}=max(nCB−nCB_{err,max}^{consecutive}, nCB−nCB_{err,max}^{nonconsecutive}) combination thereof.

10. The UE of claim 1, wherein the at least one processor is configured to cause the UE to signal:
an RRC bit field indication made by semi-static signaling;
a bit field indication made by dynamic signaling via a DCI scheduling at least one PDSCH transmission;
a bit field indication made by dynamic signaling via a DCI scheduling at least one group of PDSCH transmissions;
or a combination thereof.

11. The UE of claim 10, wherein the bit field indication comprises:
a necessary minimum number of correctly received CBs threshold tuple (nCB−nCB_{err,max}^{consecutive}, nCB−nCB_{err,max}^{nonconsecutive})lerated maximum number of CB errors threshold tuple (nCB_{err,max}^{nonconsecutive}, nCB_{err,max}^{consecutive})nimum number of correctly received CBs threshold scalar as nCB_{correct}^{necessary}; or
a tolerated maximum number of CB errors threshold scalar as nCBₑᵣᵣ^{tolerated}.

12. The UE of claim 10, wherein an encoding and bit length of the bit field indication is determined by:
a dynamic encoding as either ┌log₂(a)+log₂(b)┐ bits for a tuple threshold (a, b), or as ┌log₂(a)┐ bits for a scalar threshold of numeric value a; or
a semi-static fixed encoding of an indexed representation signaled by upper layers describing a plurality of possible threshold values, wherein the indexed representation maps to an associated threshold value.

13. The UE of claim 1, wherein the NC-aware HARQ process reports an acknowledgment (ACK) as HARQ feedback for a TB of the at least one TB in response to:
a number of correctly received CBs being greater than or equal to the CB threshold as a necessary minimum number of correctly received CBs;
a number of erroneously received CBs being less than or equal to the CB threshold as a tolerated maximum number of CB errors;
or a combination thereof.

14. A method performed by a user equipment (UE), the method comprising:
determining a network coding (NC) configuration for transmission of a scheduled network-coded application data unit (ADU);
receiving the scheduled network-coded ADU in at least one transport block (TB);
determining, for each TB of the at least one TB, a code block (CB) threshold based at least on the NC configuration;
configuring, for each TB of the at least one TB, a NC-aware hybrid automatic repeat request (HARQ) process as a HARQ process with the CB threshold;
using the CB threshold to determine a NC-aware HARQ feedback report; and
feeding back the NC-aware HARQ feedback report to a transmitting device.

15. A base station, comprising:
at least one memory; and
at least one processor coupled with the at least one memory and configured to cause the base station to:
determine a network coding (NC) configuration for encoding an application data unit (ADU) for transmission over a plurality of transport blocks (TBs);
determine a plurality of CB thresholds, wherein each CB threshold of the plurality of CB thresholds corresponds to each TB of the plurality of TBs to meet for successful NC decoding and recovery of the ADU;
signal the NC configuration, the plurality of CB thresholds, or a combination thereof to a receiver device for a NC-aware hybrid automatic repeat request (HARQ) feedback of the plurality of TBs;
schedule the ADU for transmission to a receiver device; and
receive an NC-aware HARQ feedback from the receiver device for each TB of the plurality of TBs, wherein the processor applies the NC-aware HARQ feedback to determine necessary TB retransmissions of the ADU.

16. A processor for wireless communication, comprising:
at least one controller coupled with at least one memory and configured to cause the processor to:
determine a network coding (NC) configuration for transmission of a scheduled network-coded application data unit (ADU);
receive the scheduled network-coded ADU in at least one transport block (TB);
determine, for each TB of the at least one TB, a code block (CB) threshold based at least on the NC configuration;
configure, for each TB of the at least one TB, a NC-aware hybrid automatic repeat request (HARQ) process as a HARQ process with the CB threshold;
use the CB threshold to determine a NC-aware HARQ feedback report; and
feed back the NC-aware HARQ feedback report to a transmitting device.

17. The processor of claim 16, wherein the NC configuration comprises:
a type of NC codebook;
a size of an NC packet;
a size of an NC symbol;
a number of systematic network-coded information carrying packets;
a number of systematic network-coded information carrying symbols;
a number of network-coded repair packets;
a number of network-coded repair symbols;
a total number of network-coded packets;
a total number of network-coded symbols;
a maximum size of a network-coded transmission;
a redundancy level of the NC;
or a combination thereof.

18. The processor of claim 16, whereby the NC configuration is signaled by:
a semi-static radio resource control (RRC) signaling indication;
a dynamic signaling indication of a downlink control information (DCI) scheduling at least one physical downlink shared channel (PDSCH) data traffic instance;
a dynamic signaling indication of a DCI scheduling of at least one group of PDSCH data traffic instances;
or a combination thereof.

19. The processor of claim 16, wherein the CB threshold encodes:
a necessary minimum number of correctly received CB threshold;
a tolerated maximum number of CB errors threshold;
or a combination thereof.

20. The processor of claim 16, wherein a correctness of a CB is determined based on a cyclic redundancy check (CRC) comparison with a correctly received CB validating the CRC and with an erroneously received CB not validating the CRC.
